(19) United States
(12) Patent Application Publication
(10) Pub. No.: US 2006/0245972 A1
(43) Pub. Date: Nov. 2, 2006

(54) Chemical analyzer and cartridge for chemical analyzer

(76) Inventors: Yasuo Osone, Kasumigaura (JP); Michihiro Saito, Kashiwa (JP); Hiroki Ihara, Shiroi (JP); Noriyo Nishijima, Abiko (JP); Yoshihiro Nagaoka, Ishioka (JP); Naruo Watanabe, Hitachinaka (JP); Shigeyuki Sasaki, Kasumigaura (JP); Nobuyuki Maki, Tsuchiura (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/411,159

(22) Filed: Apr. 26, 2006

(30) Foreign Application Priority Data
Apr. 27, 2005 (JP) 2005-129544

(51) Int. Cl. G01N 35/00

(52) U.S. Cl. 422/64

(57) ABSTRACT

A chemical analyzer has a rotatable holding disk, test cartridges disposed thereon, and a detector. The test cartridge includes a base plate having vessels and flow channels. The base plate is covered with a cover for covering the vessels and flow channels. The holding disk is rotated to generate centrifugal force, causing a fluid to be moved from one vessel at the inner peripheral side with respect to a rotation axis of the holding disk to another vessel at the outer peripheral side with respect to the rotation axis via the flow channel. In the test cartridge, at least one reagent port is formed in the base plate, and a closed vessel containing a reagent is placed in the reagent port. The closed vessel is a microcapsule, a plastic closed vessel, or a screw-in closed vessel, for example.

### BACKGROUND OF THE INVENTION

1. Field of the Invention

The present invention relates to a chemical analyzer for performing movement, mixing, etc. of a solution by utilizing centrifugal force, and more particularly to a chemical analyzer using a detachable test cartridge.

2. Description of the Related Art

JP,A 2003-502656 (WO 00/78455) discloses a device for extracting DNA (Doxyribonucleic Acid) from a sample containing the DNA. In the disclosed device, the DNA is captured by feeding the sample containing the DNA to pass through a glass filter. Only the DNA is recovered and collected by feeding a cleaning fluid and an eluant to pass through the glass filter in which the DNA has been captured. The glass filter is attached to a rotatable structure, and reagents, such as the cleaning fluid and the eluant, are held in respective reagent reservoirs within the same structure. Each reagent is caused to flow or move under the action of centrifugal force generated with the rotation of the structure. By opening a valve disposed in a fine flow channel connecting each reagent reservoir and the glass filter, the reagent is forced to pass through the glass filter.

JP,A 2001-527220 (WO 99/33559) discloses a chemical analyzer for extracting and analyzing a particular chemical substance, such as a nucleic acid, from a sample containing a plurality of chemical substances. An integrated cartridge includes therein reagents, such as a solvent, a cleaning fluid and an eluant, and a capturing component for capturing the nucleic acid. The sample containing the nucleic acid is injected into the cartridge such that the sample and the eluant are mixed with each other and are passed through the capturing component. Further, the cleaning fluid is introduced to pass through the capturing component, thus causing the eluant to pass through it. The eluant having passed through the capturing component is contacted with a PCR (Polymerase Chain Reaction) reagent and then flows into a reaction chamber.

### SUMMARY OF THE INVENTION

In the structure disclosed in the above-cited JP,A 2003-502656 (WO 00/78455), fluids including the reagents and the DNA mixed solution are caused to move as required by using many valves. Each of the valves is made of, e.g., wax that is melted by heating. The method using the wax is able to physically close the flow channel and to reliably control the liquid flow. On the other hand, that method requires a resistor to be disposed corresponding to each valve and also requires a means for heating the resistor to be disposed. Therefore, the rotatable structure (disk) is complicated and so is the entire device for realizing the required sequence.

Further, a filter for recovering the DNA from the DNA mixed solution is disposed in the small-sized structure. On that occasion, a pliable filter is inserted, along with a frit material for supporting the filter, in a slot formed in the flow channel within the rotatable structure (disk). After cutting an upper portion of the filter to be flush with the height of the disk, a sealing material is bonded to an upper surface of the disk.

In order to reliably ensure the flow of the DNA mixed solution through the filter, the filter has to be disposed in the flow channel with no leakage. If there is a gap between the filter and the flow channel, the DNA mixed solution flows through the gap, and the DNA in the leaked solution is not recovered on the filter, thus resulting in a reduction of the DNA recovery rate. The above-described filter mounting method is apt to cause a small gap between the filter and the sealing material. In particular, when the filter is pliable, it is very difficult, in spite of using the frit material as a support, to mount the filter and fabricate the disk in such a manner that no leakage occurs. This is similarly applied to a gap possibly caused between a bottom surface of the slot and the filter.

Also, in the integrated fluid manipulating cartridge disclosed in JP,A 2001-527220 (WO 99/33559), when each reagent is fed by a pump, a valve or the like disposed in a fine flow channel connecting each reagent chamber and the capturing component is opened to pass the capturing component. That construction also requires many valves to be provided on the cartridge, and therefore has the problem that the cartridge is complicated.

In a chemical analyzer using a test cartridge, a plurality of regents having different liquid qualities (such as viscosity, density, surface tension, and a contact angle) are caused to flow by utilizing only centrifugal force, siphonage, and capillary attraction, in order to perform various kinds of treatments, such as mixing, dissolution, capturing, elution, and cleaning. For ensuring reliable performance of those various kinds of treatments, the reagent to be caused to flow is required to reliably move through the flow channel, and the reagent to be retained is required to be reliably retained in a vessel. In other words, mobility and retention are required. In the chemical analyzer, those various kinds of treatments have to be performed with high stability of 99.9999%, for example, and mobility and retention at a high level are demanded to realize such high stability.

Accuracy in dispensing (pipetting) the reagent is one factor affecting the mobility and the retention. When the reagent is manually or automatically dispensed into a reagent vessel provided in the test cartridge, an error occurs in amount of the dispensed reagent. In the case of manual dispensing, particularly, there is a possibility of causing not only a variation in the amount of the dispensed reagent, but also a leakage. Further, the known test cartridge has a difficulty in operations of, e.g., packaging, collecting and delivering the cartridges.

An object of the present invention is to provide a chemical analyzer and a cartridge for the chemical analyzer using the cartridge, which are able to avoid an error and variation in amount of a dispensed reagent, and leakage of the dispensed reagent, etc. in a reagent dispensing step.

To achieve the above object, the chemical analyzer of the present invention comprises a holding disk rotatable by a motor, a plurality of test cartridges disposed on the holding disk, a perforator for perforating the test cartridge, a heater, and a detector. The test cartridge includes a base plate having vessels and flow channels. The base plate is covered with a cover for covering the vessels and the flow channels. The holding disk is rotated to generate centrifugal force, thereby causing a fluid to be moved from one vessel positioned in the inner peripheral side with respect to a rotation axis of the holding disk to another vessel positioned in the outer peripheral side with respect to the rotation axis via the flow channel.

In the test cartridge, at least one reagent port is formed in the base plate, and a closed vessel containing a reagent is placed in the reagent port. The closed vessel is one of a microcapsule, a plastic-made closed vessel, a screw-in closed vessel, etc.

When the closed vessels are delivered, those closed vessels containing reagents requiring no pretreatment prior to the start of a test are set on the test cartridge, while those closed vessels containing reagents requiring pretreatment prior to the start of a test are not set on the test cartridge.

According to the present invention, it is possible to not only avoid an error and variation in amount of a dispensed reagent, leakage of the dispensed reagent, etc. in a reagent dispensing step, but also to simplify operations required for, e.g., packaging, collecting and delivering the cartridges.

### BRIEF DESCRIPTION OF THE DRAWINGS

FIG. 1 is a perspective view showing the entire construction of a chemical analyzer according to the present invention;

FIG. 2 is a schematic view for explaining a test cartridge according to the present invention;

FIG. 3 is a flowchart for explaining an outline of manipulating procedures when a process of extracting a virus nucleic acid from whole blood is performed by using the chemical analyzer according to the present invention;

FIG. 4 is a flowchart for explaining an outline of processing when the process of extracting a virus nucleic acid from whole blood is performed by using the chemical analyzer according to the present invention;

FIG. 5 illustrates procedures in handling the test cartridge when a microcapsule as a first example of a reagent vessel according to the present invention is used;

FIGS. 6A-6H are explanatory views showing successive steps when the microcapsule as the first example of the reagent vessel according to the present invention is ruptured by using a heat source, e.g., a laser beam;

FIGS. 7A-7H are explanatory views showing successive steps when the microcapsule as the first example of the reagent vessel according to the present invention is externally ruptured by using mechanical means, e.g., a needle;

FIGS. 8A-8I are explanatory views showing successive steps when the microcapsule as the first example of the reagent vessel according to the present invention is ruptured by using mechanical means, e.g., a needle, disposed inside the test cartridge;

FIG. 9 illustrates successive steps of fabricating a reagent-containing closed vessel, which is a second example of the reagent vessel according to the present invention;

FIG. 10 illustrates examples of an ID marker affixed to the reagent-containing closed vessel, which is the second example of the reagent vessel according to the present invention;

FIG. 11 illustrates reagent ports each formed in the test cartridge to contain the reagent-containing closed vessel, which is the second example of the reagent vessel according to the present invention;

FIGS. 12A-12D illustrate the shapes of the reagent-containing closed vessels, each of which is the second example of the reagent vessel according to the present invention, and the shapes of the corresponding reagent ports formed in the test cartridge;

FIG. 13 illustrates procedures in handling the test cartridge when the reagent-containing closed vessel is used which is the second example of the reagent vessel according to the present invention;

FIGS. 14A-14H are explanatory views showing successive steps when a cover of the reagent-containing closed vessel, which is the second example of the reagent vessel according to the present invention, is ruptured by using the heat source, e.g., the laser beam;

FIGS. 15A-15H are explanatory views showing successive steps when the cover of the reagent-containing closed vessel, which is the second example of the reagent vessel according to the present invention, is externally ruptured by using mechanical means, e.g., a needle;

FIGS. 16A-16H are explanatory views showing successive steps when the cover of the reagent-containing closed vessel, which is the second example of the reagent vessel according to the present invention, is ruptured by using mechanical means, e.g., a projection, provided on a cartridge cover;

FIG. 17 illustrates a method for mounting, to the test cartridge, a screw-in closed vessel which is a third example of the reagent vessel according to the present invention;

FIGS. 18A and 18B illustrate the screw-in closed vessel which is the third example of the reagent vessel according to the present invention, including an ID marker affixed to the reagent port of the test cartridge;

FIG. 19 illustrates procedures in handling the test cartridge when the screw-in closed vessel is used which is the third example of the reagent vessel according to the present invention, the procedures covering until a reagent-cartridge kit is used for a test;

FIGS. 20A-20E are explanatory views showing successive steps when a cover of the screw-in closed vessel, which is the third example of the reagent vessel according to the present invention, is ruptured by using the heat source, e.g., the laser beam;

FIGS. 21A-21E are explanatory views showing successive steps when the cover of the screw-in closed vessel, which is the third example of the reagent vessel according to the present invention, is externally ruptured by using mechanical implement, e.g., a needle;

FIGS. 22A-22E are explanatory views showing successive steps when the cover of the screw-in closed vessel, which is the third example of the reagent vessel according to the present invention, is ruptured by using mechanical means, e.g., a projection, provided on a cartridge cover;

FIG. 23 is an explanatory view showing the case where the reagent-containing closed vessel which is the second example of the reagent vessel according to the present invention and the screw-in closed vessel which is the third example of the reagent vessel according to the present invention are both mounted in one test cartridge; and

FIG. 24 illustrates procedures for packaging and delivering the test cartridges the reagent-containing closed vessel which is the second example of the reagent vessel according to the present invention and the screw-in closed vessel which is the third example of the reagent vessel according to the present invention are both mounted in one test cartridge.

### DESCRIPTION OF THE PREFERRED EMBODIMENTS

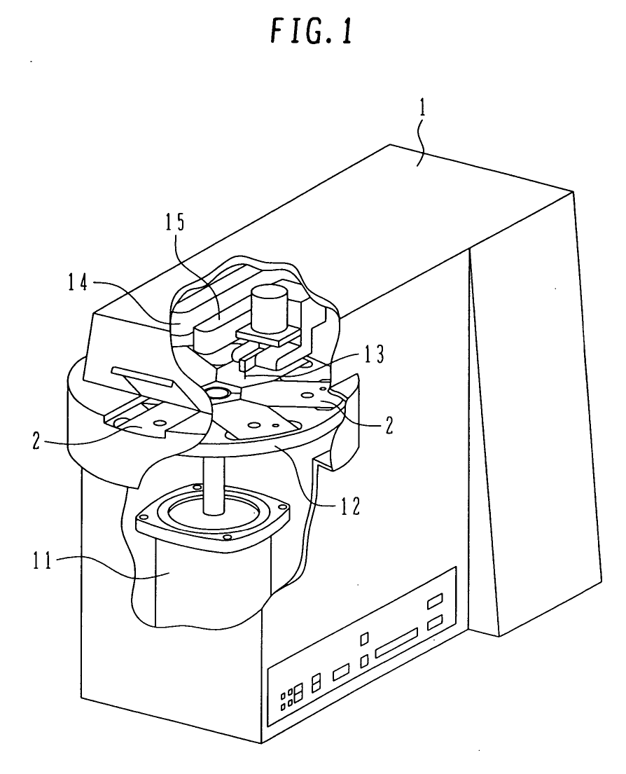

FIG. 1 shows one example of a chemical analyzer according to the present invention. A chemical analyzer 1 comprises a motor 11, a holding disk 12 rotatable by the motor 11, a plurality of test cartridges 2 disposed on the holding disk 12, a perforator 13 for perforating the test cartridge 2, a heater 14, and a detector 15. An operator prepares the test cartridge 2 for each test item, mounts it to the holding disk 12, and starts the operation of the chemical analyzer 1.

While in the chemical analyzer of this example the heater 14 and the detector 15 are disposed in separate positions, those two devices may be integrated, as another example, into an integral unit such that heating and detection are performed at the same position. Also, while the heater and the detector are positioned in the upper side of the holding disk 12, either one or both of them may be disposed in the lower side of the holding disk 12.

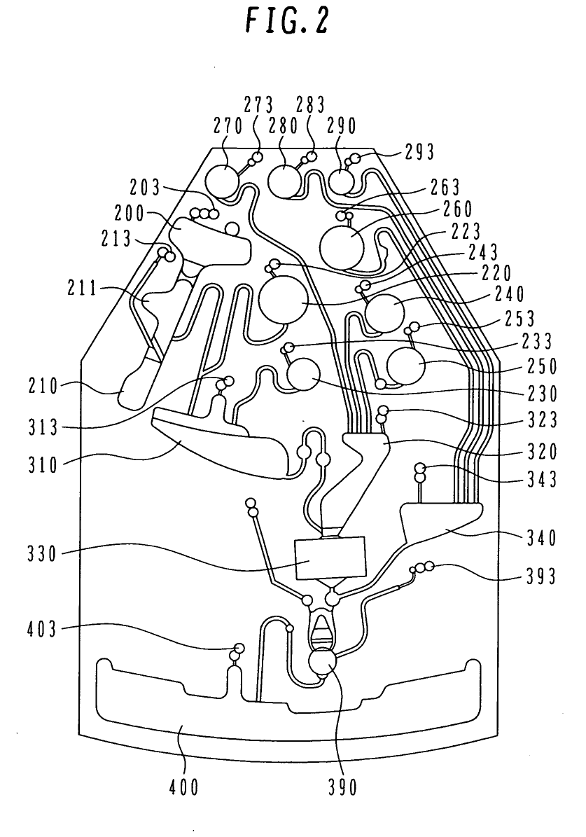

The structure of the test cartridge 2 will be described below with reference to FIG. 2. The test cartridge 2 is formed of a thin base plate having a substantially hexagonal shape. A short side of the hexagonal shape is arranged in the inner peripheral side close to the rotation center of the holding disk 12, and a long side of the hexagonal shape is arranged in the outer peripheral side of the holding disk 12. Hereinafter, the short and long sides of the hexagonal shape are referred to as the “inner peripheral side” and the “outer peripheral side”, respectively.

The test cartridge 2 includes a lysis fluid vessel 220, an added fluid vessel 230, cleaning fluid vessels 240, 250 and 260, an eluant vessel 270, and amplifying fluid vessels 280, 290. An outlet flow channel is formed in the outer peripheral side of each of those reagent vessels 220, 230, 240, 250, 260, 270, 280 and 290. The outlet flow channel includes a bent portion that is started from the outer peripheral side of the reagent vessel, is bent toward the inner peripheral side, and is extended toward the outer peripheral side.

Piercing-target portions 223, 233, 243, 253, 263, 273, 283 and 293 are formed respectively in the inner peripheral sides of the reagent vessels 220, 230, 240, 250, 260, 270, 280 and 290 with air flow channels and air filters interposed between them.

The test cartridge 2 further includes a sample vessel 200, a blood cell storage vessel 210, a blood serum determination vessel 211, a blood serum reaction vessel 310, a nucleic acid capturing section pre-vessel 320, a nucleic acid capturing section 330, a buffer vessel 340, an eluant recovery vessel 390, and a waste fluid vessel 400.

Also, piercing-target portions 203, 213, 313, 323, 343, 393 and 403 are formed respectively in the inner peripheral sides of the reagent vessels 200, 210, 310, 320, 340, 390 and 400 with air flow channels and air filters interposed between them.

The structure of the reagent vessel will be described in detail later. The sample vessel 200, the blood cell storage vessel 210, the blood serum determination vessel 211, the blood serum reaction vessel 310, the nucleic acid capturing section pre-vessel 320, the nucleic acid capturing section 330, the buffer vessel 340, the eluant recovery vessel 390, the waste fluid vessel 400, the outlet flow channels, the air flow channels, and the piercing-target portions are recesses formed in an upper surface of the test cartridge 2.

A cartridge cover formed of a film or a thin plate, for instance, is stuck or bonded to the upper surface of the test cartridge 2 so as to cover the entire upper surface of the test cartridge 2. Accordingly, the vessels, the outlet flow channels, the air flow channels, the air filters, and the piercing-target portions form closed spaces.

In this example, a reagent or a solution is caused to move between two vessels connected to each other via the flow channel by utilizing centrifugal force. First, the cartridge cover is pierced in the piercing-target portions connected respectively to the inner peripheral sides of the two vessels, thereby releasing the two vessels to the atmosphere. Then, the holding disk 12 is rotated such that the reagent or the solution in the vessel is moved from one in the inner peripheral side to the other in the outer peripheral side under the action of centrifugal force. By successively repeating those steps of manipulations, a predetermined process can be performed.

When the detector 15 is disposed in the upper side of the holding disk 12 as in the chemical analyzer 1 shown in FIG. 1, the material property of the cartridge cover is required to be not obstructive to the detection. When the detector 15 is disposed in the lower side of the holding disk 12, the bottom surface shape, the thickness and the material property of the test cartridge are required to be not obstructive to the detection.

The following description is made of the case of extracting a viral nucleic acid by using the test cartridge 2 when whole blood is used as a sample.

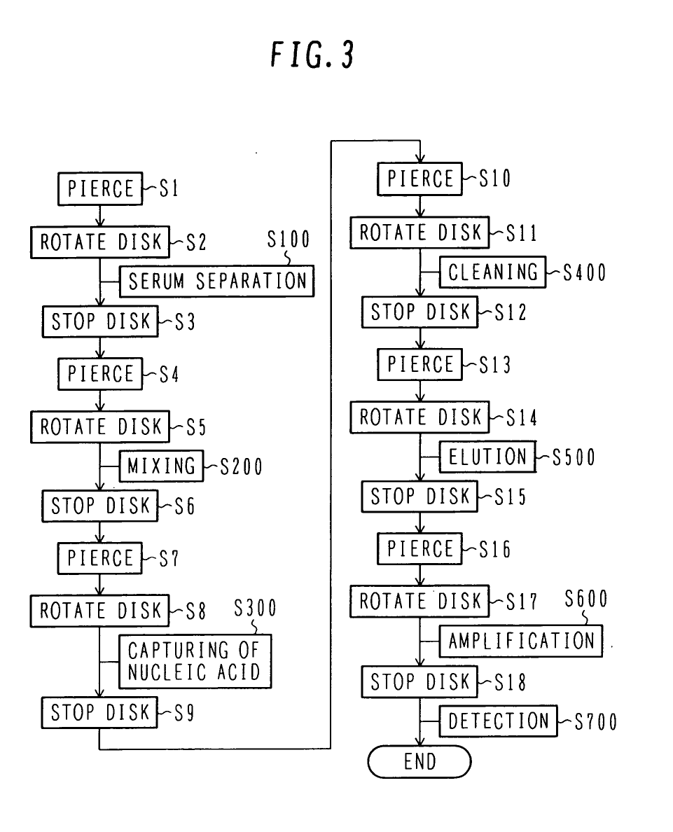

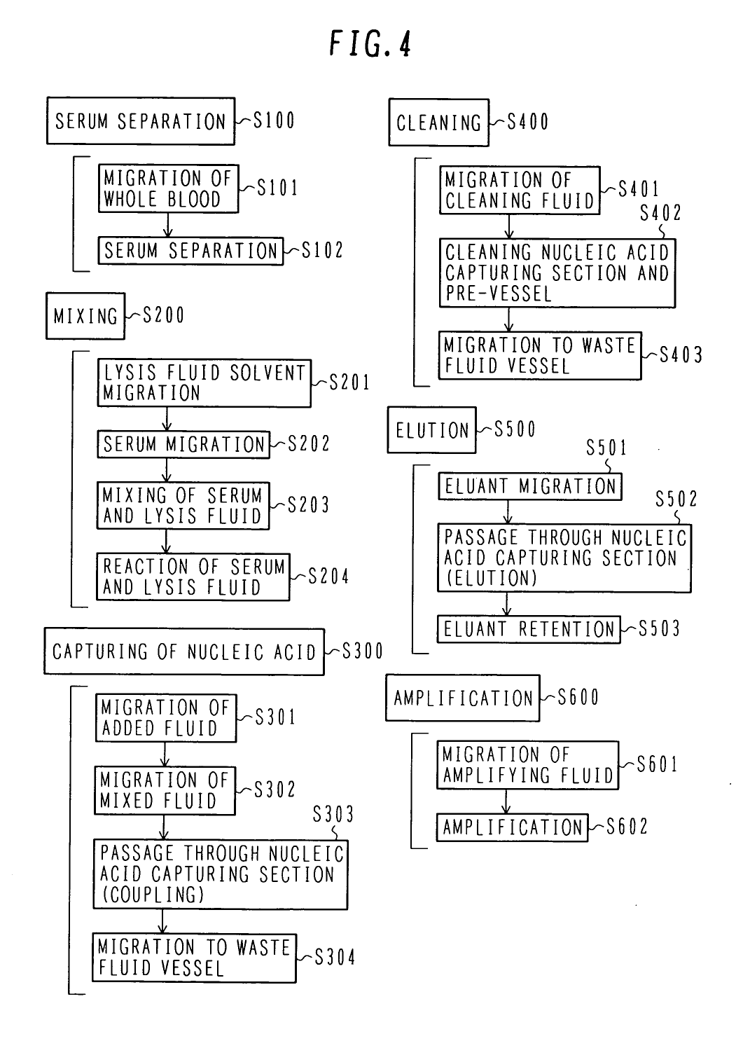

FIG. 3 shows the schematic flow of operations of the chemical analyzer. FIG. 4 shows the details of each operation. In step S1, piercing is performed. More specifically, the cartridge cover is pierced in the piercing-target portions 203 and 213 such that the sample vessel 200 and the blood cell storage vessel 210 are communicated with the atmospheric pressure. In step S2, the holding disk 12 is rotated. With the disk rotation, the blood serum in the whole blood is separated from the blood cell in step S100. The serum separation in step S100 includes two steps as shown in FIG. 4. In migration of the whole blood in step S101, the whole blood in the sample vessel 200 is moved toward the blood serum determination vessel 211 and the blood cell storage vessel 210. A dam is provided between the blood serum determination vessel 211 and the blood cell storage vessel 210. In serum separation of step S102, therefore, the blood cell in the blood serum determination vessel 211 is caused to move into the blood cell storage vessel 210 over the dam under the action of centrifugal force. Thus, the blood cell is collected in the blood cell storage vessel 210, and the blood serum is collected in the blood serum determination vessel 211, respectively. In step S3, the rotation of the holding disk 12 is stopped.

In step S4, the cartridge cover is pierced in the piercing-target portions 223 and 313 such that the lysis fluid vessel 220 and the blood serum reaction vessel 310 are communicated with the atmospheric pressure. In step S5, the holding disk 12 is rotated. With the disk rotation, the blood serum and a lysis fluid are mixed with each other in the blood serum reaction vessel 310 in step S200. The mixing in step S200 includes four steps as shown in FIG. 4. In lysis fluid migration of step S201, the lysis fluid in the lysis fluid vessel 220 is moved to the blood serum reaction vessel 310. In serum migration of step S202, the blood serum in the blood serum determination vessel 211 is moved to the blood serum reaction vessel 310. In mixing of the blood serum and the lysis fluid in step S203, the blood serum and the lysis fluid are mixed with each other. Thus, in step S204, the blood serum and the lysis fluid react with each other. In step S6, the rotation of the holding disk 12 is stopped.

In step S7, the cartridge cover is pierced in the piercing-target portions 233, 393 and 403 such that the added fluid vessel 230, the eluant recovery vessel 390, and the waste fluid vessel 400 are communicated with the atmospheric pressure. In step S8, the holding disk 12 is rotated. With the disk rotation, the nucleic acid is captured in step S300. The capturing of the nucleic acid in step S300 includes four steps as shown in FIG. 4. In migration of an added fluid in step S301, the added fluid in the added fluid vessel 230 is moved to the blood serum reaction vessel 310. In migration of a mixed fluid in step S302, the mixed fluid in the blood serum reaction vessel 310 is pushed by the added fluid and is moved to the nucleic acid capturing section 330. With passage through the nucleic acid capturing section in step S303, the mixed fluid passes through the nucleic acid capturing section 330. In step S304, the mixed fluid having passed through the nucleic acid capturing section 330 is moved to the waste fluid vessel 400 via the eluant recovery vessel 390. In step S9, the rotation of the holding disk 12 is stopped.

A cleaning step will be described below. The cleaning step includes first, second and three cleaning steps. In each of those cleaning steps, the operations of steps S10-S12 and S400 are repeated. The first cleaning step is performed as follows. In step S10, the cartridge cover is pierced in the piercing-target portions 243 and 323 such that the first cleaning fluid vessel 240 and the nucleic acid capturing section pre-vessel 320 are communicated with the atmospheric pressure. In step S11, the holding disk 12 is rotated. With the disk rotation, cleaning is performed in step S400. The cleaning of step S400 includes three steps as shown in FIG. 4. In migration of the cleaning fluid in step S401, the cleaning fluid in the first cleaning fluid vessel 240 is moved to the nucleic acid capturing section 330 via the nucleic acid capturing section pre-vessel 320. In step S402, the cleaning fluid in the first cleaning fluid vessel 240 flows through the nucleic acid capturing section pre-vessel 320 and the nucleic acid capturing section 330 for cleaning them. In step S403, the cleaning fluid having passed through the nucleic acid capturing section 330 is moved to the waste fluid vessel 400 via the eluant recovery vessel 390. In step S12, the rotation of the holding disk 12 is stopped.

The second cleaning step is performed as follows. In step S10, the cartridge cover is pierced in the piercing-target portion 253 such that the second cleaning fluid vessel 250 is communicated with the atmospheric pressure. In step S11, the holding disk 12 is rotated. With the disk rotation, cleaning is performed in step S400. The subsequent processing is similar to that in the first cleaning step. In step S12, the rotation of the holding disk 12 is stopped.

The third cleaning step is performed as follows. In step S10, the cartridge cover is pierced in the piercing-target portions 263 and 343 such that the third cleaning fluid vessel 260 and the buffer vessel 340 are communicated with the atmospheric pressure. In step S11, the holding disk 12 is rotated. With the disk rotation, the cleaning is performed in step S400. In migration of the cleaning fluid in step S401, the cleaning fluid in the third cleaning fluid vessel 260 is moved to the eluant recovery vessel 390 via the buffer vessel 340. In step S402, the cleaning fluid in the third cleaning fluid vessel 260 flows through the eluant recovery vessel 390 for cleaning it. In step S403, the cleaning fluid having passed through the eluant recovery vessel 390 is moved to the waste fluid vessel 400. In step S12, the rotation of the holding disk 12 is stopped.

In step S13, the cartridge cover is pierced in the piercing-target portion 273 such that the eluant vessel 270 is communicated with the atmospheric pressure. In step S14, the holding disk 12 is rotated. With the disk rotation, elution is performed in step S500. The elution of step S500 includes three steps as shown in FIG. 4. In eluant migration of step S501, the eluant in the eluant vessel 270 is moved to the nucleic acid capturing section 330 via the nucleic acid capturing section pre-vessel 320. In step S502, the eluant flows through the nucleic-acid capturing section 330 to elute the nucleic acid captured in the nucleic acid capturing section 330. In step S503, the eluant having eluted the nucleic acid is retained in the eluant recovery vessel 390. In step S15, the rotation of the holding disk 12 is stopped.

In step S16, the cartridge cover is pierced in the piercing-target portions 283 and 293 such that the first amplifying fluid vessel 280 and the second amplifying fluid vessel 290 are successively communicated with the atmospheric pressure. In step S17, the holding disk 12 is rotated. With the disk rotation, amplification is performed in step S600. The amplification of step S600 includes two steps as shown in FIG. 4. In migration of an amplifying fluid in step S601, the amplifying fluid in the first amplifying fluid vessel 280 is moved to the eluant recovery vessel 390 via the buffer vessel 340. The amplifying fluid in the second amplifying fluid vessel 290 is also moved to the eluant recovery vessel 390 via the buffer vessel 340. In step S602, the nucleic acid in the eluant recovery vessel 390 is amplified by the amplifying fluids. At that time, the eluant recovery vessel 390 is heated. In step S19, the rotation of the holding disk 12 is stopped.

In step S700, detection is performed. Specifically, the nucleic acid in the eluant recovery vessel 390 is detected by the detector.

Various examples of the reagent vessel formed in the test cartridge according to the present invention will be described below. A first example of the reagent vessel is first described with reference to FIGS. 5-8. The reagent vessel according to the first example is a microcapsule 500. The microcapsule 500 containing a reagent is placed in a corresponding recess formed in a test cartridge 20. The recess is referred to as a “reagent port 21” hereinafter.

The microcapsule 500 is a small-sized capsule in which a liquid reagent or a powdery reagent is enclosed by using a film-like coating. The microcapsule 500 is already used in various fields. Also, there are known various methods for producing the microcapsule 500. For instance, when the reagent is oil-soluble, the microcapsule 500 can be produced by forming a liquid coating so as to surround the oil-soluble reagent, and then solidifying the liquid coating. When the reagent is water-soluble, the microcapsule 500 can be produced by forming a capsular vessel in advance, pouring the water-soluble reagent in the capsular vessel, and then closing a pouring port.

FIG. 5 illustrates procedures ranging from a step of placing the microcapsules 500 on a test cartridge 20 to a step of using the test cartridge 20 for a test. In step S801, the microcapsule 500 is placed in each of the reagent ports 21 formed in the test cartridge 20. Preferably, specific features are imparted to both of the microcapsule 500 and the reagent port 21 so that the microcapsule 500 can be placed in the predetermined reagent ports 21 without errors. For instance, the microcapsule 500 is formed into a spindle-shaped capsule with a specific aspect ratio differing per reagent, and the reagent port 21 is formed into a shape complementary to the shape of the microcapsule 500. Such a contour feature is effective in preventing the microcapsule 500 from being placed in the false reagent port 21. Further, the reagent port 21 and the microcapsule 500 in pair may be painted with the same color or provided with the same mark for identification.

In step S802, a cartridge cover 30 is attached to an upper surface of the test cartridge 20. The test cartridge 20 is packaged in step S803 and then delivered in step S804. The delivered test cartridge 20 is preserved on the cartridge receiving side in step S805 and then used for a test in step S806. During the course of the delivery from the sending side to the receiving side, the test cartridge 20 is managed in match with the reagent that requires the most stringent management conditions. For instance, when one of the reagents requires cryogenic management, temperature management is performed to be adapted for the temperature condition required for that one reagent. To that end, the test cartridge 20 is preferably delivered by using, e.g., a refrigerator truck 501 capable of performing temperature control and is preserved in environment controllable equipment, e.g., a cool box 502, on the receiving side.

According to this first example, each of the reagents set on the test cartridge 20 is protected by the coating film covering the microcapsule 500, it is possible to avoid the problems of accidental outflow, contamination possibly occurred during a long-term storage, and deactivation. Also, because the microcapsule 500 contains the reagent in exact amount, it is possible to avoid an error and variation in amount of a dispensed reagent by an operator.

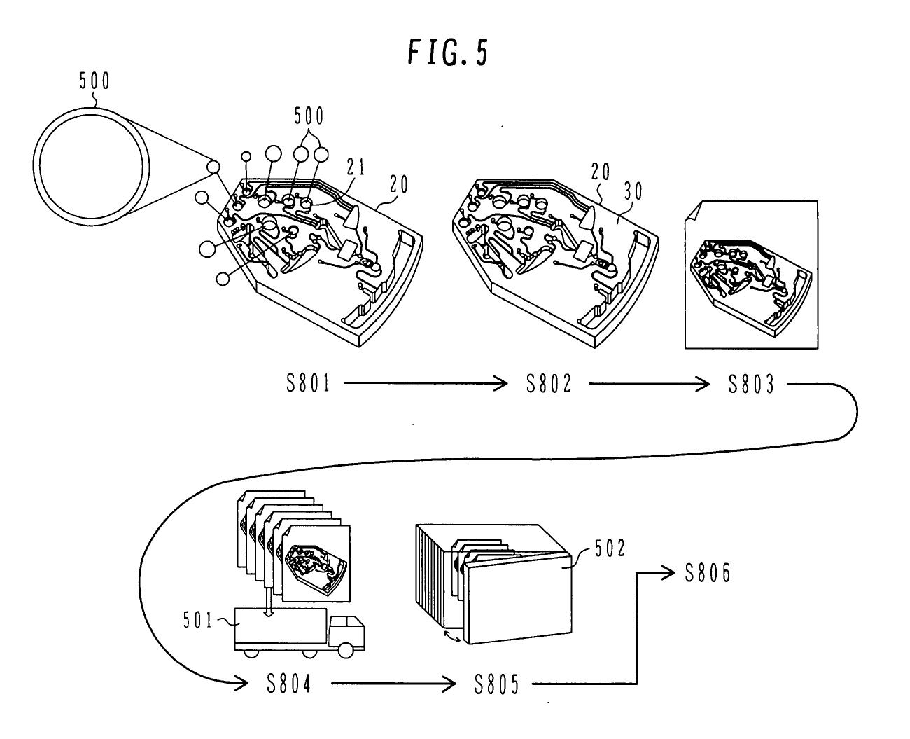

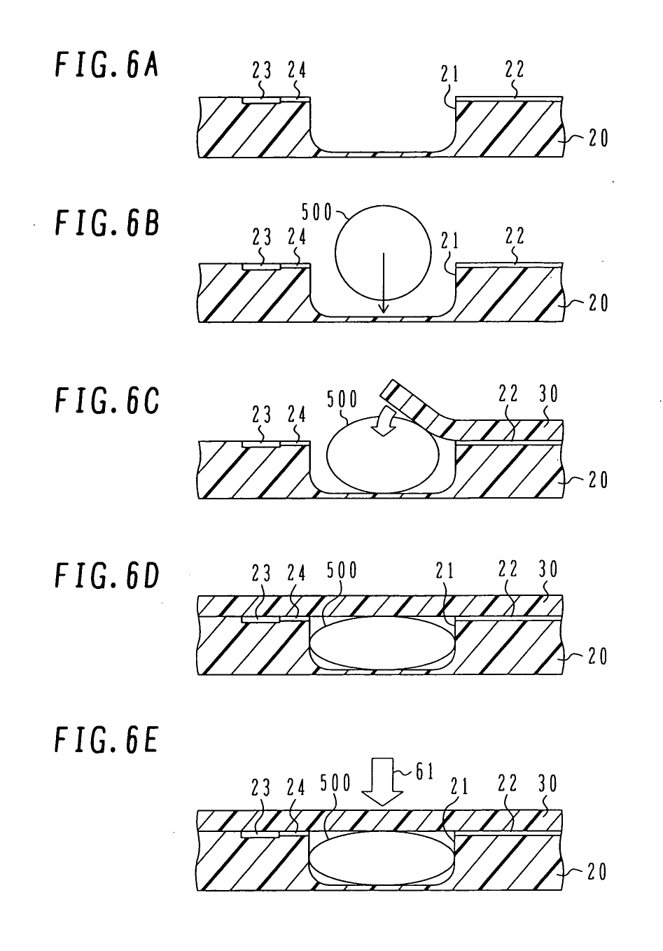

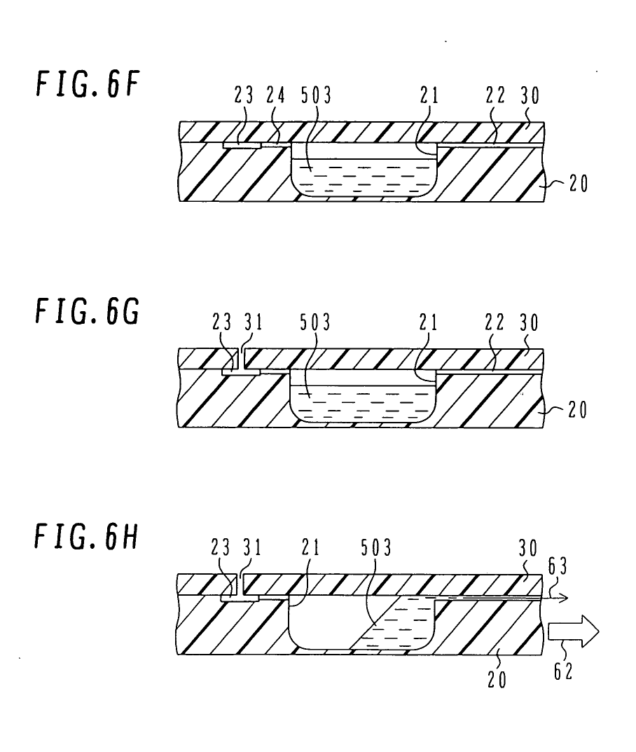

A series of manipulations necessary for the first example of the reagent vessel placed in the test cartridge 20 will be described below with reference to FIGS. 6A-6H. FIG. 6A shows the reagent port 21 formed in the test cartridge 20. A piercing-target portion 23 is formed in the inner peripheral side of the reagent port 21. The piercing-target portion 23 is communicated with the reagent port 21 via an air flow channel 24. An outlet flow channel 22 is formed in the outer peripheral side of the reagent port 21. As shown in FIG. 6B, the microcapsule 500 is first placed in the reagent port 21. Then, as shown in FIG. 6C, the cartridge cover 30 is attached to the upper surface of the test cartridge 20. FIG. 6D shows a state where the reagent port 21, the piercing-target portion 23, the air flow channel 24, and the outlet flow channel 22 are closed by the cartridge cover 30.

Then, as shown in FIG. 6E, the microcapsule 500 is ruptured. In the illustrated instance, a laser beam 61 is irradiated to the microcapsule 500 through the cartridge cover 30. With the irradiation of the laser beam 61, the microcapsule 500 is heated, melted and ruptured. The intensity of the laser beam 61 irradiated to the microcapsule 500 must be set to a such a level as enabling the microcapsule 500 to be melted, but as not melting the cartridge cover 30.

The cartridge cover 30 is made of a material having a very high transmittance for light in the wavelength range of the laser beam 61 used. At least a part of the coating film of the microcapsule 500 is made of a material or painted with a color, which has a high absorbance for the light in the wavelength range of the laser beam 61 used.

Induction heating may be used instead of irradiating the laser beam 61. In this case, the cartridge cover 30 is made of a material that is not affected by the induction heating. On the other hand, the coating film of the microcapsule 500 is made of a material that is easily susceptible to the induction heating. Further, a contact heating method is also usable instead of irradiating the laser beam 61 or performing the induction heating.

FIG. 6F shows a state where the microcapsule 500 is ruptured and the reagent 503 in the microcapsule 500 is filled in the reagent port 21. Then, as shown in FIG. 6G, the cartridge cover 30 is pierced in the piercing-target portion 23. The reagent port 21 is thereby communicated with the atmospheric pressure via a hole 31. Then, as shown in FIG. 6H, the holding disk 12 is rotated. The reagent 503 in the reagent port 21 is flown out in the direction of an arrow 63 under the action of centrifugal force 62 to move toward another vessel in the outer peripheral side via the outlet flow channel 22.

In this instance, because at least a part of the coating film of the microcapsule 500 is heated, the reagent 503 in the microcapsule 500 is never to be the type having reactivity affected by the heating. When the reagent is, e.g., an enzyme possibly deactivated at high temperatures, the method of this instance should not be used. When that type of the reagent is used, the microcapsule 500 is ruptured by using mechanical means as described below.

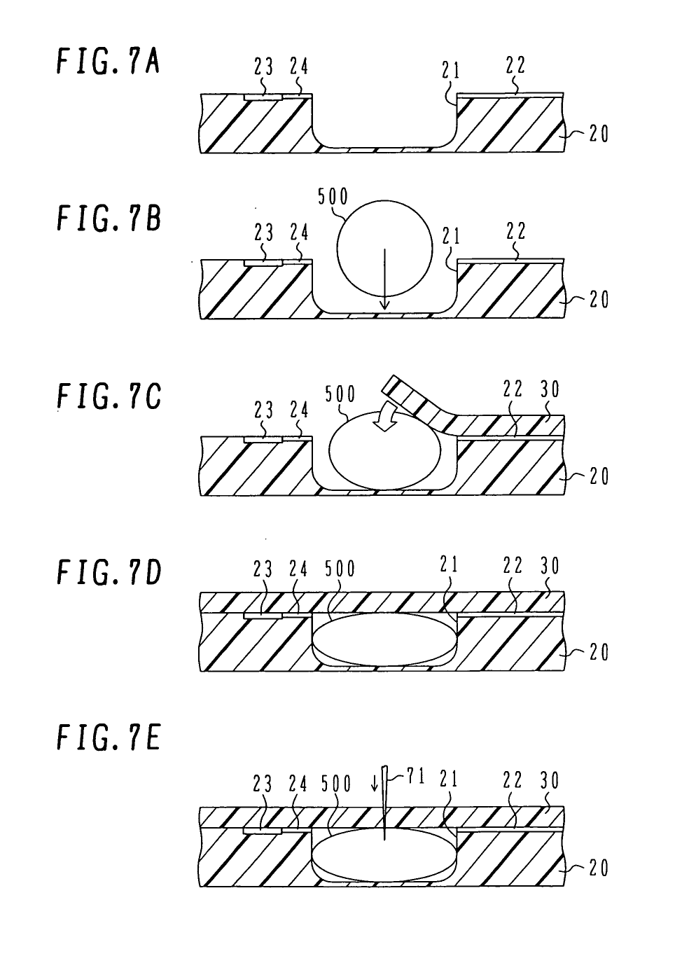

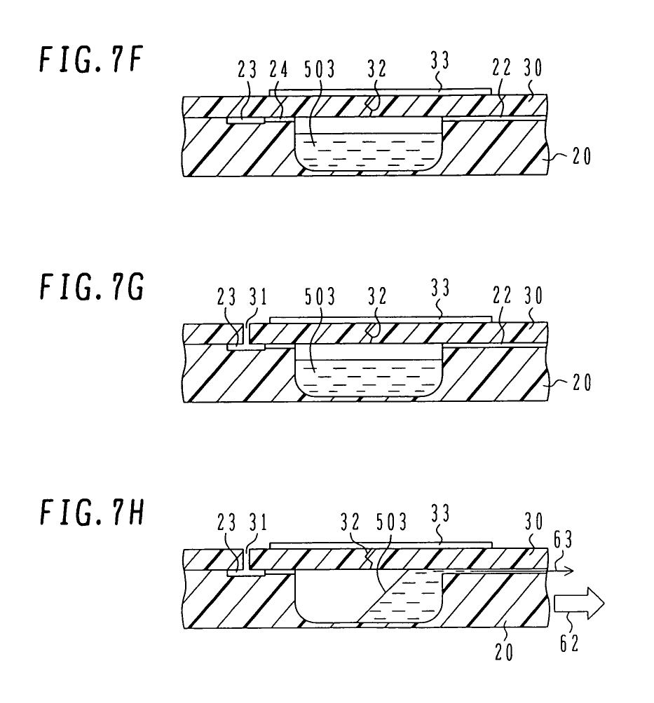

FIGS. 7A-7H show a series of manipulations necessary for the first example of the reagent vessel placed in the test cartridge 20 similarly to FIGS. 6A-6H. The manipulations shown in FIGS. 7A-7H differ from those shown in FIGS. 6A-6H in a manner of rupturing the microcapsule 500. FIGS. 7A-7D are the same as FIGS. 6A-6D, respectively, and a description of FIGS. 7A-7D is omitted here.

In this instance, as shown in FIG. 7E, the microcapsule 500 is ruptured by using a needle 71. The needle 71 is pushed down from above the cartridge cover 30 to penetrate through the cartridge cover 30 to such an extent that the needle 71 is pierced into the microcapsule 500. As a result, the microcapsule 500 is ruptured and the reagent 503 in the microcapsule 500 is filled in the reagent port 21.

As shown in FIG. 7F, a hole 32 formed in the cartridge cover 30 by the needle 71 is sealed off by coating a sealing material 33.

Then, as shown in FIG. 7G, the cartridge cover 30 is pierced in the piercing-target portion 23. The reagent port 21 is thereby communicated with the atmospheric pressure via a hole 31. Then, as shown in FIG. 7H, the holding disk 12 is rotated. The reagent 503 in the reagent port 21 is flown out in the direction of an arrow 63 under the action of centrifugal force 62 to move toward another vessel in the outer peripheral side via the outlet flow channel 22.

In this instance, there are no particular limitations in colors and materials of the cartridge cover 30 and the microcapsule 500, but the hole 32 formed in the cartridge cover 30 by the needle has to be sealed off by coating the sealing material or the like.

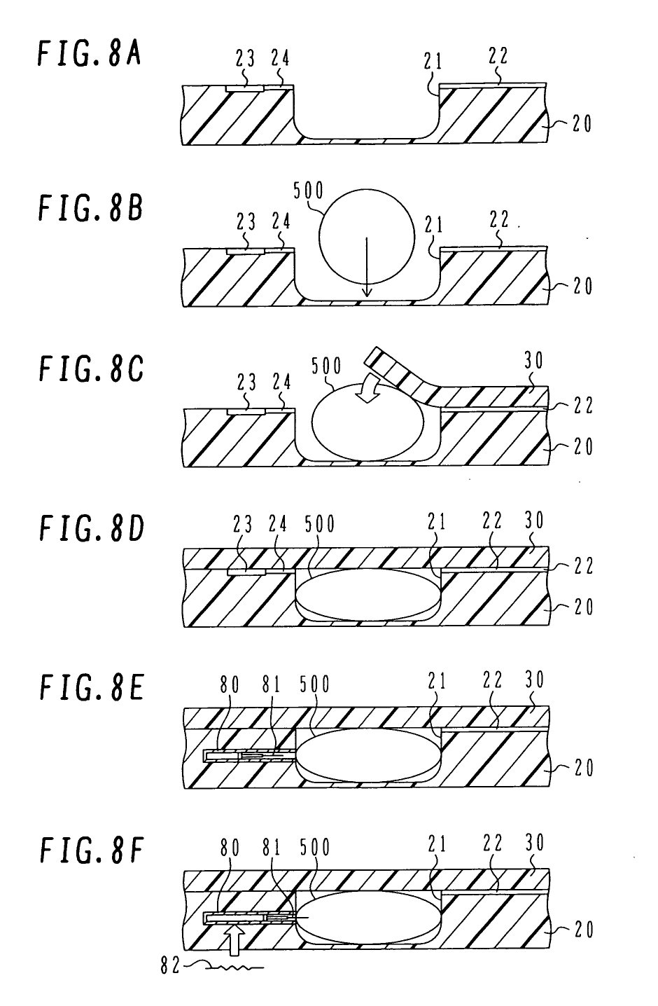

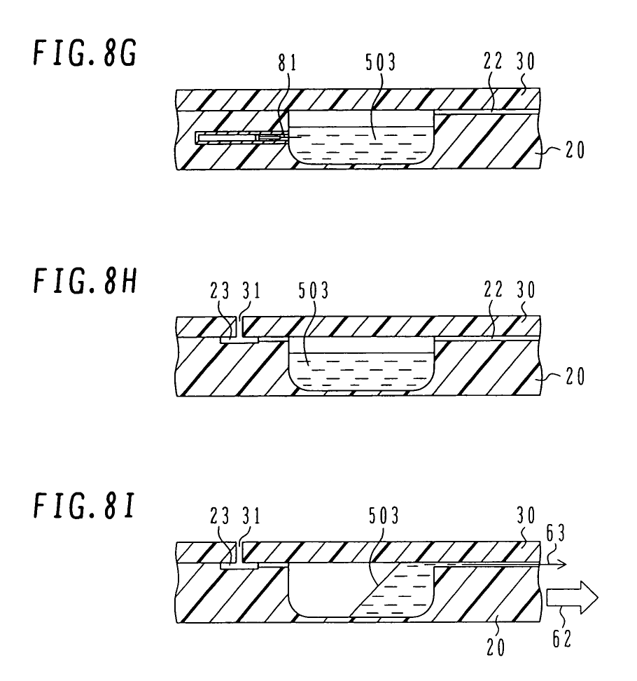

FIGS. 8A-8I show a series of manipulations necessary for the first example of the reagent vessel placed in the test cartridge 20 similarly to FIGS. 6 and 7. The manipulations shown in FIGS. 8A-8I differ from those shown in FIGS. 6 and 7 in a manner of rupturing the microcapsule 500. FIGS. 8A-8D are the same as FIGS. 6A-6D, respectively, and a description of FIGS. 8A-8D is omitted here.

FIGS. 8E-8G are each a sectional view of the test cartridge 20 cut along a vertical plane not including the piercing-target portion 23 and the outlet flow channel 22.

In this instance, as shown in FIG. 8E, the microcapsule 500 is ruptured by using a needle 81 which is incorporated in the test cartridge 20 beforehand. More specifically, a horizontal slot 80 is formed in the test cartridge 20 to be open in an inner wall of the reagent port 21, and the needle 81 is movably disposed in the slot 80. The needle 81 is movable in the axial direction by an appropriate driver 82. The needle driver 82 can be constituted by, e.g., a pneumatic spring mechanism for moving the needle by a pneumatic spring in a reciprocating manner like a piston, or a magnetic force mechanism for moving the needle by magnetic force in a reciprocating manner. The needle and the needle driver may be integrated into one unit. In this case, the integral unit may be press-fitted in a countersunk hole formed in the test cartridge 20, followed by sealing-off.

As shown in FIG. 8F, the needle 81 is projected into the reagent port 21 by operating the driver 82 for the needle 81. The microcapsule 500 is ruptured by the projected needle 81. When the needle driver 82 includes the pneumatic spring mechanism, air in the pneumatic spring is heated so as to expand. With the air expansion, the pneumatic spring is extended, to thereby project the needle 81. When the needle driver 82 includes the magnetic force mechanism, a magnetic field is generated such that the needle 81 is moved by the generated magnetic field.

FIG. 8G shows a state where the microcapsule 500 is ruptured and the reagent 503 in the microcapsule 500 is filled in the reagent port 21. FIGS. 8H and 8I are each a sectional view of the test cartridge 20 cut along a vertical plane including the piercing-target portion 23 and the outlet flow channel 22. As shown in FIG. 8H, the cartridge cover 30 is pierced in the piercing-target portion 23. The reagent port 21 is thereby communicated with the atmospheric pressure via a hole 31. Then, as shown in FIG. 8I, the holding disk 12 is rotated. The reagent 503 in the reagent port 21 is flown out in the direction of an arrow 63 under the action of centrifugal force 62 to move toward another vessel in the outer peripheral side via the outlet flow channel 22.

Although the structure of the needle driver is complicated, this instance is advantageous in requiring neither the heating of the microcapsule 500, nor the sealing-off of the hole formed in the test cartridge 20.

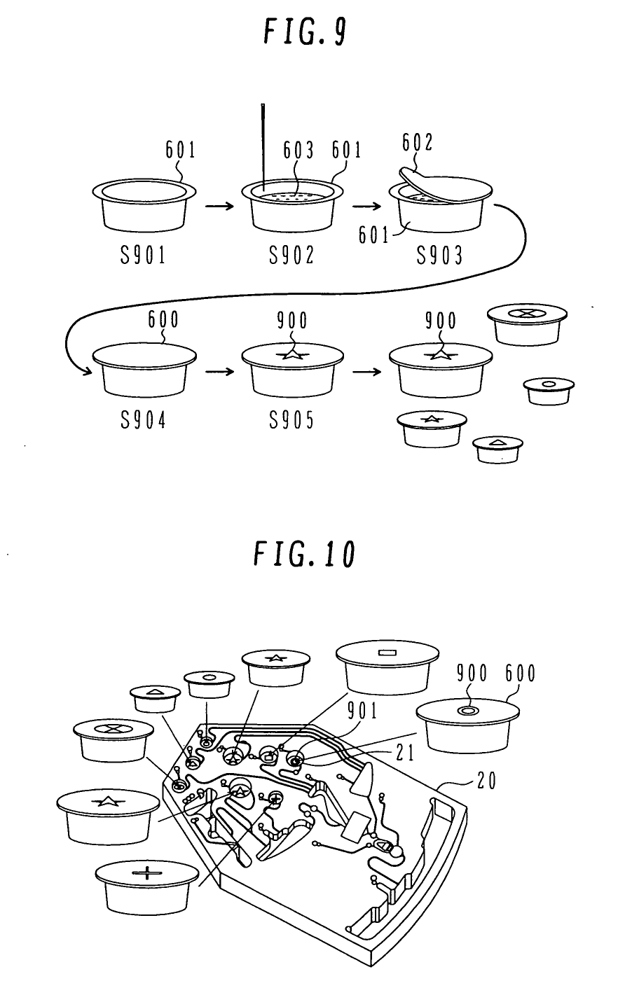

A second example of the reagent vessel will be described below with reference to FIGS. 9-16. In this second example, a closed vessel equipped with a lid is used instead of the microcapsule 500. The closed vessel equipped with the lid, which contains a reagent, is placed in the reagent port 21 of the test cartridge 20. After placing the closed vessel equipped with the lid in the reagent port 21 of the test cartridge 20, the closed vessel and the reagent port 21 may be securely stuck or bonded to each other by an adhesive, ultrasonic bonding, or fusion welding with heat, etc.

One instance of the closed vessel is a plastic-made closed vessel commercially used as a container for pudding or yogurt, but the closed vessel is not limited to such an instance. A material of the closed vessel, i.e., each of materials of the closed vessel and the lid, preferably has the coefficient of thermal expansion being the same as or close to that of the test cartridge 20.

For instance, if the material of the closed vessel has the coefficient of thermal expansion larger than that of the test cartridge 20, there is a possibility that the reagent vessel placed in the reagent port 21 of the test cartridge 20 is pressed against an inner wall of the reagent port 21 by thermal expansion, thus causing a deformation or breakage of the reagent vessel. Conversely, if the material of the closed vessel has the coefficient of thermal expansion smaller than that of the test cartridge 20, there is a possibility that a gap is formed between the reagent vessel and the inner wall of the reagent port 21, and the reagent enters the gap when the cartridge cover 30 is ruptured. Also, when the reagent vessel is bonded to the reagent port 21 of the test cartridge 20 by an adhesive or fusion welding, there is a possibility that the bonded portion is peeled off due to the difference in thermal expansion. When the coefficient of thermal expansion of the closed vessel is the same as or close to that of the test cartridge 20, the above-mentioned drawbacks caused by the difference in thermal expansion can be avoided.

The material of the closed vessel is preferably selected so as to ensure that the reagent in the closed vessel will not degrade even in the case of long-term storage. From that point of view, it is preferable that the material of the closed vessel has air-tightness and does not react with the reagent. So long as those conditions are satisfied, the closed vessel can be made of any kind of material, e.g., plastic, resin, glass, paper, metal, or metal coated with a resin film on its surface. Also, the closed vessel may be manufactured by any suitable working method, e.g., molding or cutting. Further, the lid may be made of the same material as the closed vessel, but it may be also made of a material different from that of the closed vessel like the above-mentioned closed container used for containing foods.

The lid is preferably made of a material having not only the coefficient of thermal expansion, which is the same as or close to that of the test cartridge, but also air-tightness and no reactivity with the reagent. When the piercing is performed by an optical method using a white light source (such as a halogen lamp), a blackening process is required for the lid surface to increase the light absorbance. When a light source having a particular wavelength, e.g., a laser beam, is used, the lid is made of a material having a peak of the absorbance in the range including the wavelength of the light source. In the latter case, the lid may be covered with a coating film that is transparent in the above wavelength range. An aluminum-based sealing material is used for the lid in the following description, but the present invention is not limited to the use of that material.

A method of manufacturing the reagent-containing closed vessel according to the second example will be described below with reference to FIG. 9. While the reagent-containing closed vessel according to the second example can be formed into suitable one of various shapes such as a cylinder, a rectangular column, an inverted circular truncated cone, and an inverted frustum of a pyramid, the following description is made on the case of the closed vessel having the shape of an inverted circular truncated cone. The external shape of the closed vessel is selected such that the closed vessel can be easily placed in the reagent port of the test cartridge. When the closed vessel is inserted into the reagent port of the test cartridge with its bottom surface going ahead, the bottom surface is required to have an area being smaller than or equal to that of a top surface of the closed vessel. In the case of the closed vessel having the shape of an inverted circular truncated cone, the closed vessel is inserted into the reagent port while its bottom surface having a smaller area is directed ahead. Further, angled corners of the closed vessel may be chamfered. An inner space of the closed vessel is preferably formed such that the bottom surface has a smaller area than the top surface, for the purpose of enabling the reagent in the closed vessel to be smoothly flown out up to the last.

In step S901, a vessel body 601 is prepared. An inner surface of the vessel body 601 is subjected to proper surface treatment, or the vessel body 601 is made of a material having high air-tightness to ensure that the reagent, moisture, air, etc. are not permeable between the interior of the vessel body and external environment even with the lapse of a long time. In step S902, a reagent 603 is dispensed into the vessel body 601. The reagent 603 is dispensed in such a proper amount that the vessel body 601 is not fully filled with the reagent up to its capacity and a space is left above a surface level of the reagent.

In step S903, a lid 602 is attached to the vessel body 601. In step S904, the lid 602 is securely bonded to the vessel body 601. The lid 602 is made of, e.g., an aluminum-based sealing material that is usually used for packaging pharmaceuticals. The sealing material is securely bonded to a rim face of the vessel body 601 by ultrasonic bonding, fusion welding with heat, or any other suitable method. Thus, a closed vessel 600 is completed in which the reagent is enclosed.

Preferably, the reagent dispensing operation in step S902, the lid attaching operation in step S903, and the lid bonding operation in step S904 are performed in an atmosphere of vacuum or inert gas. Therefore, the interior of the closed vessel is in vacuum or contains the inert gas enclosed in it.

In step S905, a marker 900 for identifying the kind of the reagent is affixed to an outer surface of the closed vessel 600 containing the reagent. Alternatively, the lid may have the ID marker 900 printed thereon beforehand. The ID marker 900 can be given in the form including a character, a symbol, a color, etc.

FIG. 10 illustrates a manner of placing the closed vessel 600 containing the reagent in the reagent port 21 of the test cartridge 20. A marker 901 for identifying the kind of the reagent is affixed to a bottom surface or a rim of the reagent port 21. The closed vessel 600 containing the reagent is placed in the reagent port 21 such that the ID marker 900 affixed to the closed vessel 600 containing the reagent is matched with the ID marker 902 affixed to the reagent port 21. As an alternative, a non-contact RF-ID (Radio Frequency Identification) tag may be attached to the lid 602 to be detected by the chemical analyzer 1. The closed vessel 600 containing the reagent and the reagent port 21 may be securely stuck or bonded to each other by an adhesive, ultrasonic bonding, or fusion welding with heat, etc.

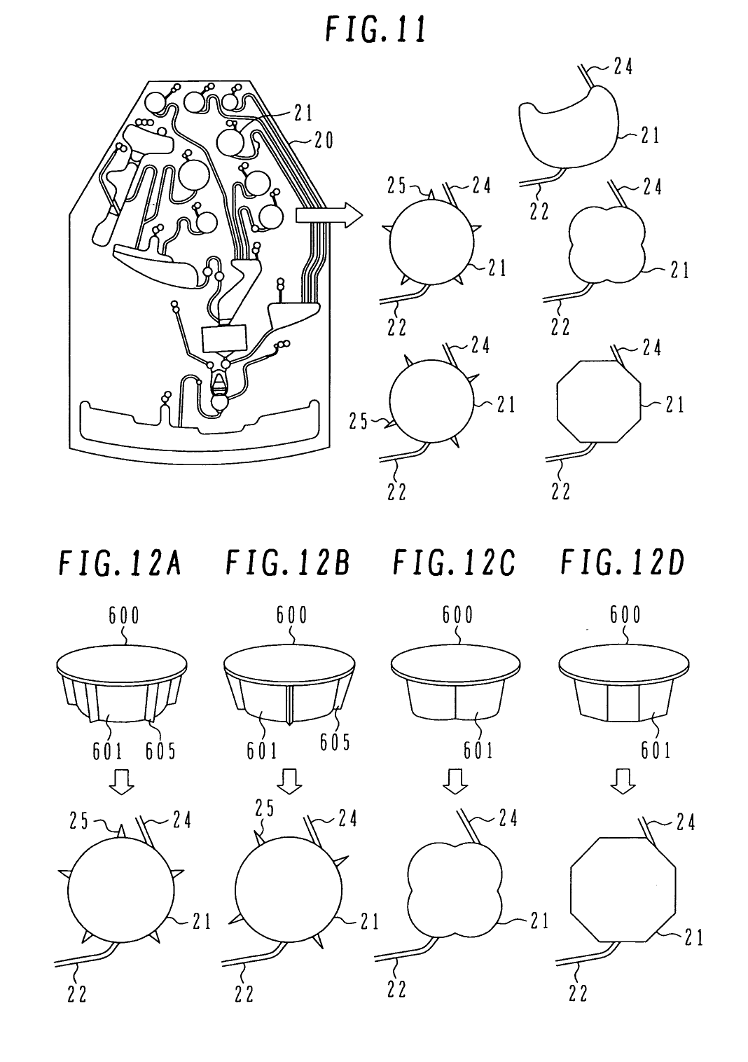

FIGS. 11 and 12 illustrate a manner of preventing errors in placement operation by forming the reagent ports 21 and the closed vessels 600 containing the reagents to have different shapes in pairs. As shown in FIG. 11, the reagent ports 21 formed in the test cartridge 20 have different shapes in one-to-one relation to the reagents. For instance, each of the reagent ports 21 has a circular shape including one or more wedge-like recesses 25 raidally projected from a circumference, or any of polygonal, elliptic, non-circular and other suitable shapes.

FIGS. 12A-12D illustrate instances of the shapes of the reagent ports 21 formed in the test cartridge 20 and the shapes of the reagent-containing closed vessels 600 placed in the corresponding reagent ports 21. As shown in each of FIGS. 12A and 12B, when the reagent port 21 has the circular shape including one or more wedge-like recesses 25 raidally projected from the circumference, the body 601 of the reagent-containing closed vessel 600 is formed into the shape of an inverted circular truncated cone including the corresponding number of projections 605 raidally projected from a circumference. As shown in each of FIGS. 12C and 12D, when the reagent port 21 has a predetermined specific shape, the body 601 of the reagent-containing closed vessel 600 is formed so as to have an external shape corresponding to the predetermined shape. Thus, because the shapes of the reagent ports 21 and the reagent-containing closed vessels 600 in pairs differ from each other per reagent, it is possible to prevent the reagent-containing closed vessel 600 from being placed in the not-corresponding reagent port 21.

While FIGS. 11 and 12 show, by way of example, several shapes of the reagent ports 21 and the reagent-containing closed vessels 600, they may also have any other suitable shapes. For instance, when the reagent-containing closed vessel 600 is formed into the shape of an inverted circular truncated cone, the vessels may have different numbers of projections or the projections arranged at irregular intervals along the vessel circumference. Additionally, the ID markers described above with reference to FIGS. 9 and 10 may also be affixed to the reagent ports 21 and the reagent-containing closed vessels 600 according to this second example in pairs.

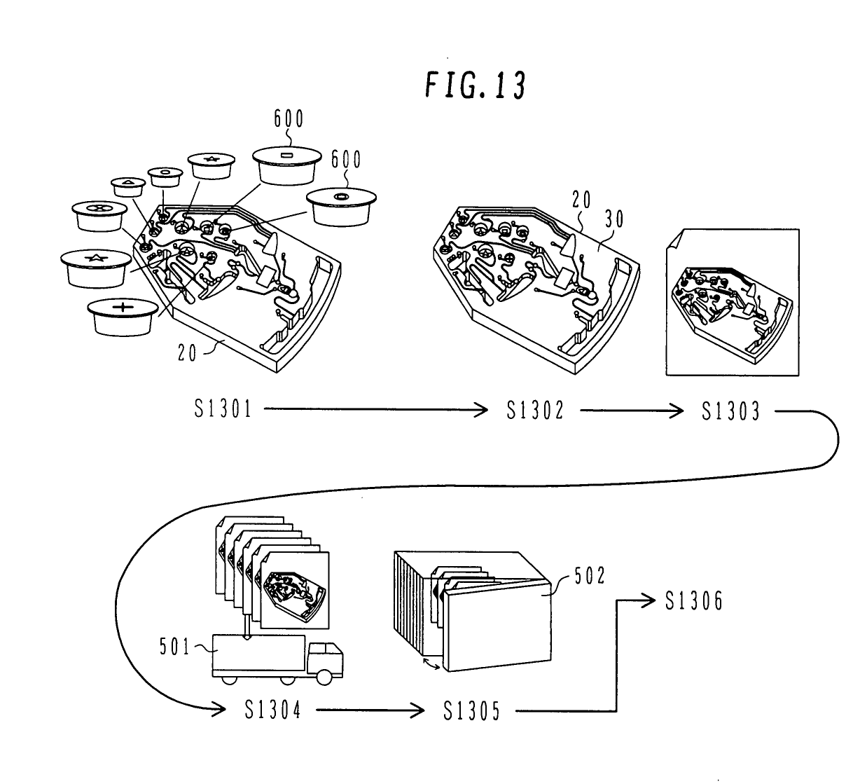

FIG. 13 illustrates, similarly to FIG. 5, the flow of operations ranging from a delivery step to a test step of the test cartridge 20 on which the reagent-containing closed vessels 600 according to this second example are placed. In step S1301, the reagent-containing closed vessel 600 is placed in corresponding one of the reagent ports 21 formed in the test cartridge 20. In step S1302, a cartridge cover 30 is attached to an upper surface of the test cartridge 20. In step S1303, the test cartridge 20 is packaged. In step S1304, the test cartridge 20 is delivered by using, e.g., a refrigerator truck 501 capable of performing temperature control. In step S1305, the delivered test cartridge 20 is preserved in environment controllable equipment, e.g., a cool box 502, on the cartridge receiving side. In step S1306, the test cartridge 20 is used for a test. According to this second example, since a test operator is not required to perform, e.g., operations of dispensing reagents and other fluids except for whole blood, it is possible to avoid an error and variation in amount of a dispensed reagent by the operator.

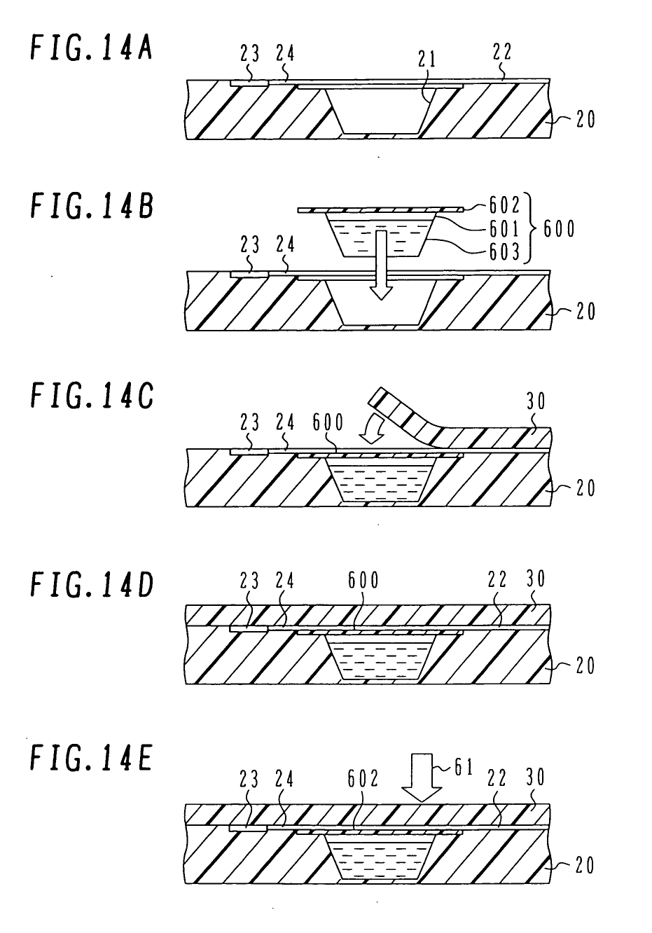

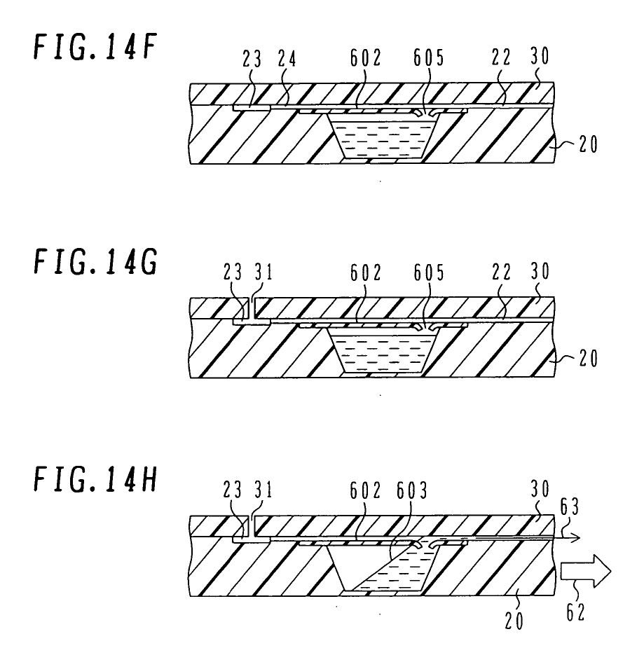

A series of manipulations necessary for the second example of the reagent vessel placed in the test cartridge 20 will be described below with reference to FIGS. 14A-14H. FIG. 14A shows the reagent port 21 formed in the test cartridge 20. In the illustrated instance, the reagent port 21 has the shape of an inverted circular truncated cone corresponding to the shape of the reagent-containing closed vessel 600. A piercing-target portion 23 is formed in the inner peripheral side of the reagent port 21. The piercing-target portion 23 is communicated with the reagent port 21 via an air flow channel 24. An outlet flow channel 22 is formed in the outer peripheral side of the reagent port 21. As shown in FIG. 14B, the reagent-containing closed vessel 600 is first placed in the reagent port 21. The reagent-containing closed vessel 600 comprises the body 601, the lid 602, and the reagent 603.

As shown in FIG. 14C, the cartridge cover 30 is attached to the upper surface of the test cartridge 20. FIG. 14D shows a state where the reagent port 21, the piercing-target portion 23, the air flow channel 24, and the outlet flow channel 22 are closed by the cartridge cover 30.

Then, in a step shown in FIG. 14E, a hole (605 see FIG. 14F) is formed in the lid 602 of the reagent-containing closed vessel 600. In the illustrated instance, a laser beam 61 is irradiated to the lid 602 of the reagent-containing closed vessel 600 through the cartridge cover 30. With the irradiation of the laser beam 61, a part of the lid 602 is heated and melted, whereby the hole 605 is formed therein. The intensity of the laser beam 61 irradiated to the lid 602 must be set to a such a level as enabling the lid 602 to be melted, but as not melting the cartridge cover 30. As in the case of FIG. 6, induction heating may be used instead of irradiating the laser beam 61.

In the illustrated instance, a space is left above a surface level of the reagent in the closed vessel. Stated another way, the surface level of the reagent is away from the lid. Accordingly, even when the lid is melted by heating, the reagent is not heated. Hence deterioration of the reagent is avoided. By using a material having a high absorbance for the laser beam 61 to form the lid, the lid can be melted by irradiating the laser beam 61 at a minimum energy level. When an ID marker is affixed to the lid, the ID marker may be formed by coating a paint having high energy absorbency, e.g., a black paint.

FIG. 14F shows a state where a part of the lid 602 is melted and the hole 605 is formed. Then, as shown in FIG. 14G, the cartridge cover 30 is pierced in the piercing-target portion 23. The reagent 603 in the vessel is thereby communicated with the atmospheric pressure via a hole 31. Then, as shown in FIG. 14H, the holding disk 12 is rotated. The reagent 603 in the vessel is flown out in the direction of an arrow 63 through the hole 605 of the lid 602 under the action of centrifugal force 62 to move toward another vessel in the outer peripheral side via the outlet flow channel 22.

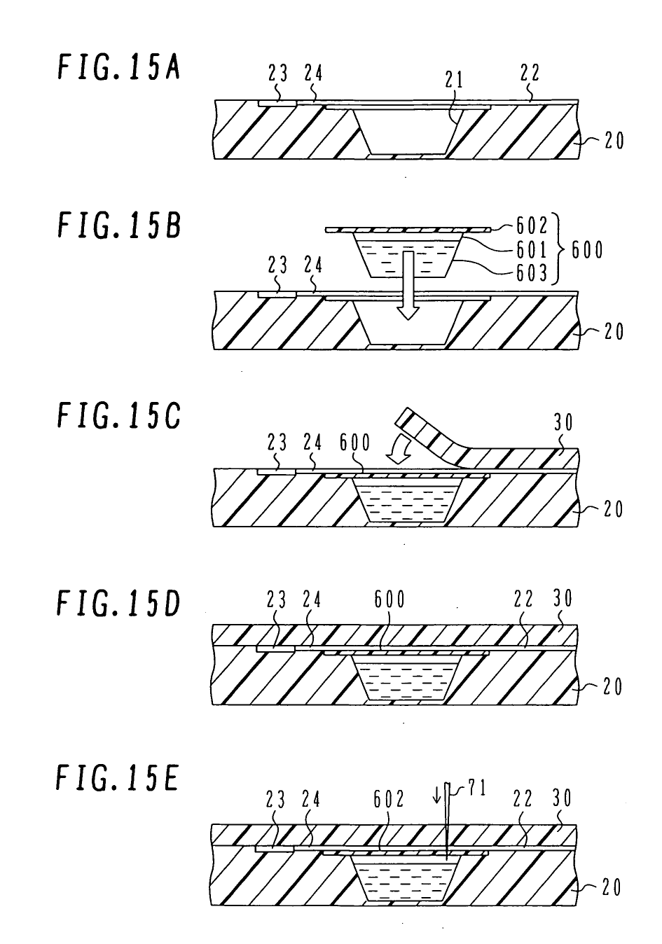

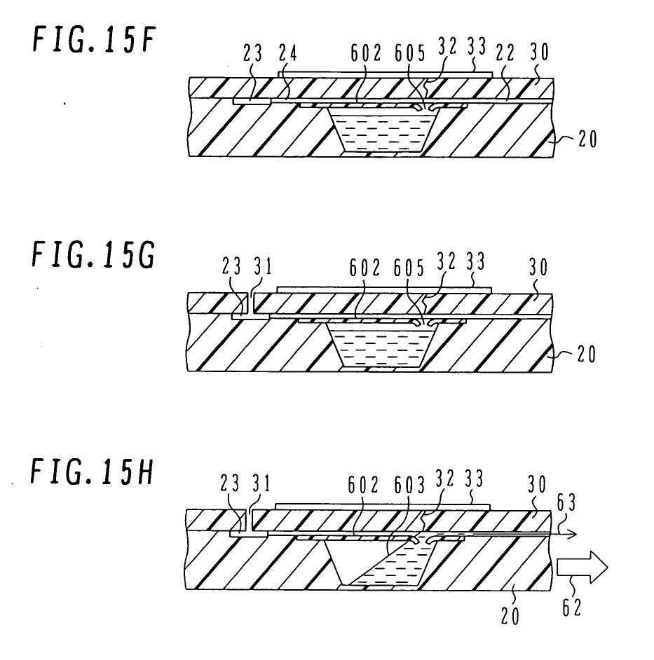

FIGS. 15A-15H show a series of manipulations necessary for the second example of the reagent vessel placed in the test cartridge 20 similarly to FIGS. 14A-14H. The manipulations shown in FIGS. 15A-15H differ from those shown in FIGS. 14A-14H in a manner of forming the hole in the lid. FIGS. 15A-15D are the same as FIGS. 14A-14D, respectively, and a description of FIGS. 15A-15D is omitted here.

In this instance, as shown in FIG. 15E, a needle 71 is pierced through the lid 602. The needle 71 is pushed down from above the cartridge cover 30 to penetrate through the cartridge cover 30 to such an extent that the needle 71 is pierced into the lid 602 of the reagent-containing closed vessel 600 positioned below the cartridge cover 30. As a result, the hole 605 is formed in the lid 602.

As shown in FIG. 15F, a hole 32 formed in the cartridge cover 30 by the needle 71 is sealed off by coating a sealing material 33.

Then, as shown in FIG. 15G, the cartridge cover 30 is pierced in the piercing-target portion 23. The reagent 603 in the vessel is thereby communicated with the atmospheric pressure via a hole 31. Then, as shown in FIG. 15H, the holding disk 12 is rotated. The reagent 603 in the vessel is flown out in the direction of an arrow 63 through the hole 605 of the lid 602 under the action of centrifugal force 62 to move toward another vessel in the outer peripheral side via the outlet flow channel 22.

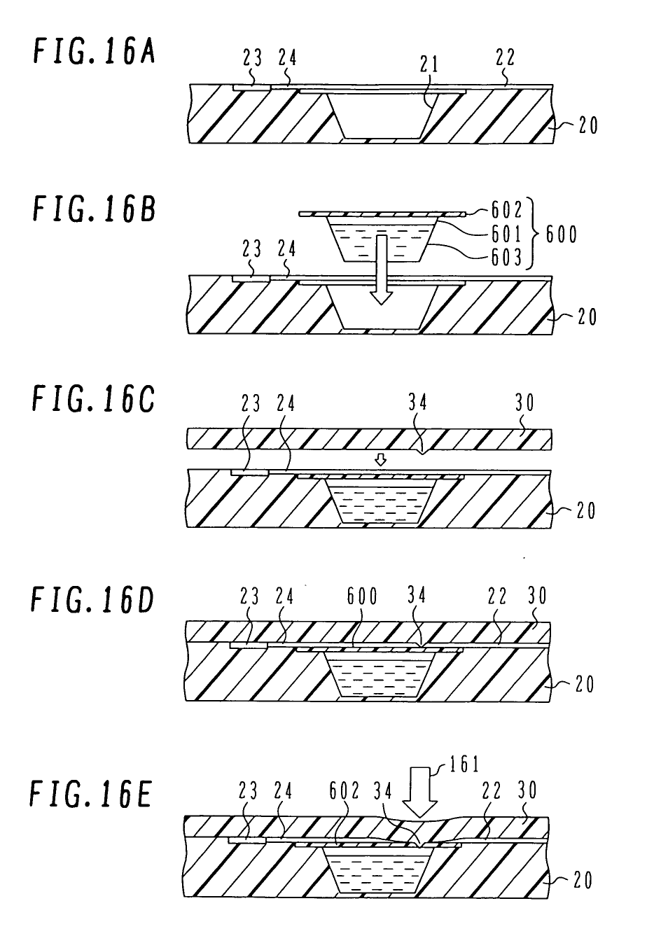

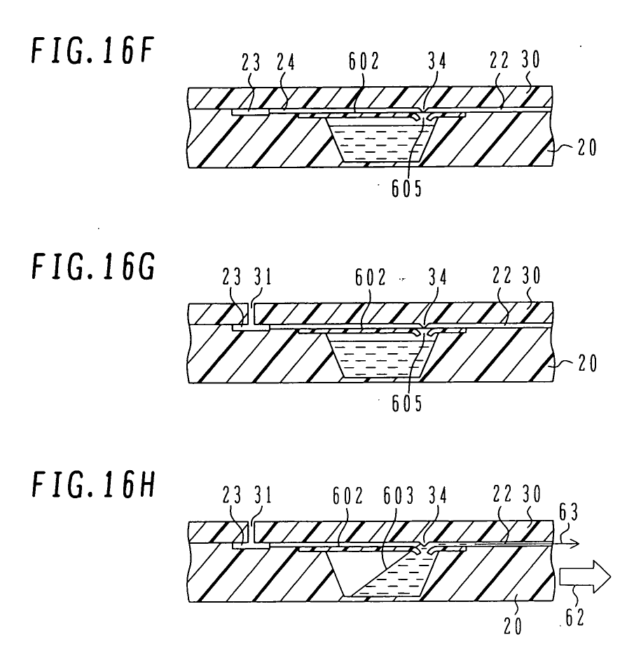

FIGS. 16A-16H show a series of manipulations necessary for the second example of the reagent vessel placed in the test cartridge 20 similarly to FIGS. 14 and 15. The manipulations shown in FIGS. 16A-16H differ from those shown in FIGS. 14 and 15 in a manner of forming the hole in the lid. FIGS. 16A and 16B are the same as FIGS. 14A and 14B, respectively, and a description of FIGS. 16A and 16B is omitted here.

In this instance, as shown in FIG. 16C, a projection 34 is formed on a lower surface of the cartridge cover 30. As shown in FIG. 16D, the cartridge cover 30 including the projection 34 is attached to an upper surface of the test cartridge 20. In this state, the projection 34 formed on the lower surface of the cartridge cover 30 is arranged so as to position just above the lid 602 of the reagent-containing closed vessel 600. The reagent port 21, the piercing-target portion 23, the air flow channel 24, and the outlet flow channel 22 are closed by the cartridge cover 30.

As shown in FIG. 16E, the cartridge cover 30 is depressed downward from above, as indicated by 161, at the position where the projection 34 is formed. With the depression of the cartridge cover 30, the projection 34 is pushed against the lid 602 and the hole 605 is formed in the lid 602. FIG. 16F shows a state where the hole 605 is formed in the lid 602 of the reagent-containing closed vessel 600. FIGS. 16G and 16H are the same as FIGS. 15G and 15H, respectively.

In the instances shown in FIGS. 14-16, the hole 605 formed in the lid 602 is preferably positioned nearer to the outlet flow channel 22 than to the center of the lid 602. Stated another way, the hole 605 formed in the lid 602 is preferably formed at a position biased toward the outlet flow channel 22 away from the center of the lid 602.

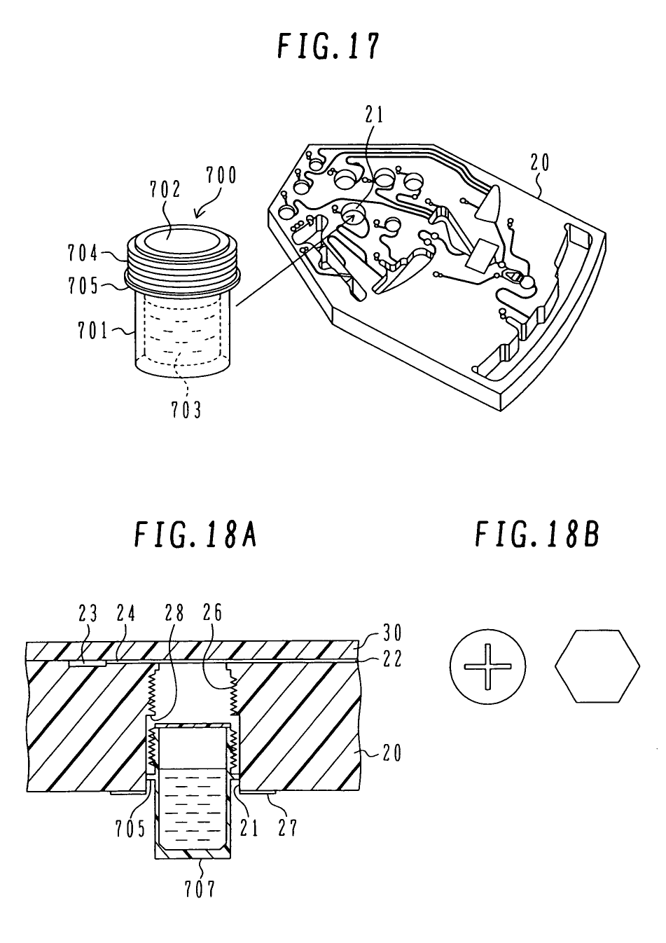

A third example of the reagent vessel will be described below with reference to FIGS. 17-22. As shown in FIG. 17, a screw-in closed vessel 700 containing a reagent, according to this third example, comprises a cylindrical vessel body 701 and a lid 702 with a reagent 703 enclosed therein. Further, a threaded portion 704 is formed on an outer periphery of the reagent vessel 700 in its upper portion, and a projection 705 is formed under the threaded portion 704 to extend along the outer periphery of the reagent vessel 700.

FIG. 18 illustrates a manner of mounting the reagent vessel 700 according to this third example to the test cartridge 20. In the illustrated instance, a through hole is formed in the test cartridge 20, and this through hole serves as a reagent port 21. A threaded portion 26 is formed in an inner periphery of the through hole in complementary relation to the threaded portion 704 of the reagent vessel 700, and a step 28 is formed at a lower end of the threaded portion 26. The closed vessel 700 containing the reagent is inserted into the reagent port 21 from the underside of the test cartridge 20, and the threaded portion 704 of the reagent-containing closed vessel 700 is engaged with the threaded portion 26 in the reagent port 21. When the reagent-containing closed vessel 700 is screwed into the reagent port 21, the projection 705 of the reagent-containing closed vessel 700 abuts against the step 28 in the reagent port 21. As a result, the reagent-containing closed vessel 700 is mounted to the test cartridge 20, and the interior of the reagent port 21 is completely closed. The reagent-containing closed vessel 700 and the reagent port 21 may be securely stuck or bonded to each other by an adhesive, ultrasonic bonding, or fusion welding with heat, etc. While, in the third example of the reagent vessel illustrated here, the reagent vessel 700 is mounted to the reagent port 21 by screwing, they may be securely stuck or bonded to each other by an adhesive, ultrasonic bonding, or fusion welding with heat, etc. without resorting to the screwing.

A piercing-target portion 23, an air flow channel 24, and an outlet flow channel 22 are formed on an outer surface of the test cartridge 20. The piercing-target portion 23 is formed in the inner peripheral side of the reagent port 21, and the outlet flow channel 22 is formed in the outer peripheral side of the reagent port 21. The air flow channel 24 and the outlet flow channel 22 are communicated with the reagent port 21. When the reagent-containing closed vessel 700 is mounted to the reagent port 21, a space is formed between the lid 702 of the reagent-containing closed vessel 700 and the cartridge cover 30. That space is communicated with the air flow channel 24 and the outlet flow channel 22. That space, the piercing-target portion 23, the air flow channel 24, and the outlet flow channel 22 are completely closed by the cartridge cover 30.

An ID marker 27 is affixed around the reagent port 21 of the test cartridge 20. On the other hand, an ID marker corresponding to the ID marker 27 is also affixed to the reagent-containing closed vessel 700. Those ID markers can be each given in the form including not only a character, a symbol, a color, etc., but also a particular shape. The provision of the ID markers is effective to prevent the reagent-containing closed vessel 700 from being mounted to the not-corresponding reagent port 21. Instead of using the ID markers, the diameters of the reagent-containing closed vessels and the reagent ports in pairs may be changed per reagent. This is also effective to prevent the reagent-containing closed vessel 700 from being mounted to the not-corresponding reagent port 21 because male and female threads having different diameters cannot be engaged with each other.

As shown in FIG. 18B, a cross-shaped groove for engagement with a screwdriver or a hexagonal head for engagement with a wrench is formed in a bottom surface of the reagent-containing closed vessel 700. Accordingly, the reagent-containing closed vessel 700 can be screwed into the reagent port 21 by using a tool, e.g., a screwdriver or a wrench (spanner).

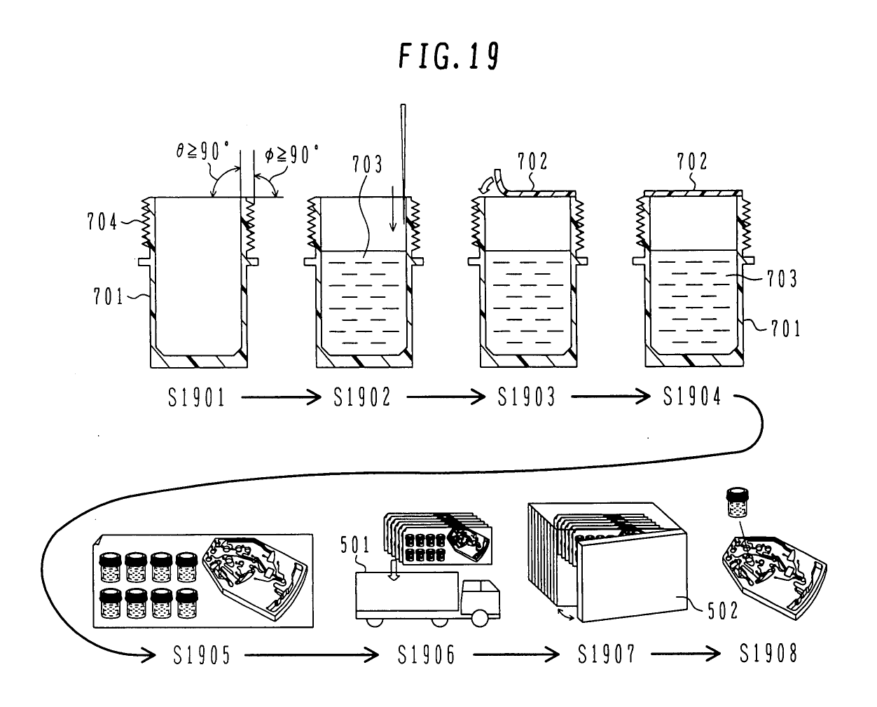

A manner of assembling and delivering the reagent-containing closed vessel of this third example will be described below with reference to FIG. 19. In step S1901, a vessel body 701 is prepared. The threaded portion 704 is formed on an outer periphery of the vessel body 701 in its upper portion. The illustrated vessel body 701 has an elongate cylindrical shape, but it may have any other suitable shape than the elongate cylindrical one. In any shape, however, the inner diameter of the vessel body 701 is set to gradually increase from the bottom side toward the opening side such that the reagent in the vessel body is easily flown out under the action of centrifugal force. To that end, an inner wall of the vessel body is preferably tapered. As shown in FIG. 19, for instance, an angle θ formed between the vessel inner wall and a plane including the vessel opening is larger than 90 degrees. Also, the outer diameter of the threaded portion 704 is set to gradually reduce toward the vessel opening for the purpose of ensuring the positive air tightness between the reagent-containing closed vessel and the test cartridge. As shown in FIG. 19, for instance, an angle φ formed between an outer surface of the threaded portion 704 and a plane including the vessel opening is larger than 90 degrees.

Also in this third example, as in the second example of the reagent vessel shown in FIGS. 9-16, an inner surface of the vessel body 701 is subjected to proper surface treatment, or the vessel body 701 is made of a material having high air-tightness to ensure that the reagent, moisture, air, etc. are not permeable between the interior of the vessel body and external environment even with the lapse of a long time.

In step S1902, a reagent 703 is dispensed into the vessel body 701. The reagent 703 is dispensed in such a proper amount that the vessel body 701 is not fully filled with the reagent up to its capacity and a space is left above a surface level of the reagent.

In step S1903, the lid 702 is attached to the vessel body 701. In step S1904, the lid 702 is securely bonded to the vessel body 701. The lid 702 is made of, e.g., an aluminum-based sealing material that is used for packaging pharmaceuticals. The sealing material is securely bonded to a rim face of the vessel body 701 by fusion welding with heat or any other suitable method. Thus, the enclosed vessel 700 is completed in which the reagent is enclosed. Preferably, the reagent dispensing operation in step S1902, the lid attaching operation in step S1903, and the lid bonding operation in step S1904 are performed in an atmosphere of vacuum or inert gas. Therefore, the interior of the reagent-containing closed vessel is in vacuum or contains the inert gas enclosed in it.

In step S1905, the reagent-containing closed vessel and the test cartridge are packaged. In this third example, the reagent-containing closed vessel is packaged in a state where it is not mounted to the test cartridge. In step S1906, the reagent-containing closed vessel and the test cartridge are delivered by using, e.g., a refrigerator truck 501. In step S1907, the delivered vessel and the test cartridge are preserved in environment controllable equipment, e.g., a cool box 502, on the receiving side. In step S1908, the reagent-containing closed vessel and the test cartridge are used in a test facility on the receiving side. In this third example, the reagent-containing closed vessel is mounted to the test cartridge prior to the use for a test. Subsequently, a sample is dispensed into the test cartridge, and the test cartridge is mounted to the rotating disk of the chemical analyzer.

Thus, in this third example, the reagent-containing closed vessel is mounted to the test cartridge prior to the use for a test. The reason is as follows. Some reagents are required to enhance reactivity by heating or stirring prior to the use for a test, while other some reagents are required to be kept from heating and stirring. If the reagent-containing closed vessel and the test cartridge are in a state where the former is mounted to the latter, it would be impossible to satisfactorily handle various kinds of reagents requiring to be treated in different individual ways. By handling the reagent-containing closed vessel and the test cartridge separately from each other, handling of the reagents adapted for individual properties can be realized.

A marker for identifying the kind of the reagent is affixed to the reagent-containing closed vessel in order to prevent the reagent-containing closed vessel from being mounted in a false position when employed on the user side. The ID marker is affixed to the lid or a lateral or bottom surface of the vessel body. The ID marker can be given in the form including a character, a symbol, a color, a shape, etc.

Further, in this third example, since the reagent-containing closed vessel is mounted to the test cartridge from the underside, the test cartridge can be delivered in a state where the cartridge cover 30 is bonded to the upper surface of the test cartridge. In other words, the user is not required to bond the cartridge cover 30 to the upper surface of the test cartridge before the use.

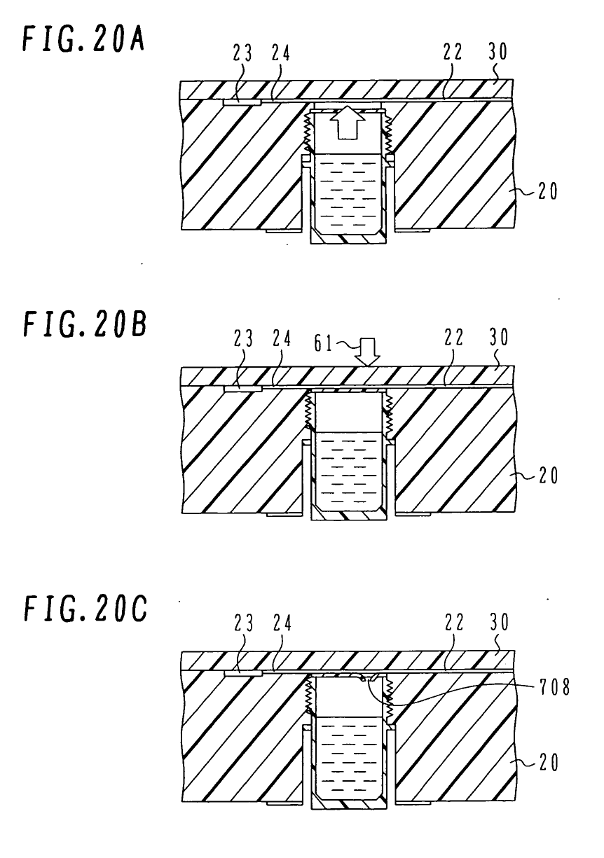

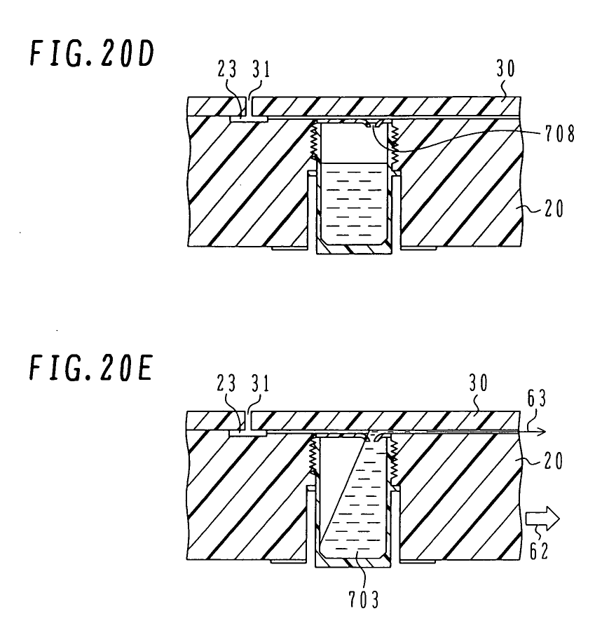

A series of manipulations necessary for the third example of the reagent vessel mounted to the test cartridge 20 will be described below with reference to FIGS. 20A-20E. FIG. 20A shows a state where the reagent-containing closed vessel 700 is mounted to the reagent port 21 formed in the test cartridge 20. The reagent-containing closed vessel 700 is inserted into the reagent port 21 of the test cartridge 20 from below, and the male threaded portion 704 of the reagent-containing closed vessel 700 is engaged in the female threaded portion 26 of the reagent port 21.

As described above, the reagent-containing closed vessel 700 is mounted to the reagent port 21 such that the ID marker affixed to the reagent-containing closed vessel 700 and the ID marker affixed to the reagent port 21 are matched with each other.

In a step shown in FIG. 20B, a hole 708 (FIG. 20C) is formed in the lid 702 of the reagent-containing closed vessel 700. In the illustrated instance, a laser beam 61 is irradiated to the lid 702 of the reagent-containing closed vessel 700 through the cartridge cover 30. With the irradiation of the laser beam 61, a part of the lid 702 is heated and melted, wherein the hole 708 is formed there. The intensity of the laser beam 61 irradiated to the lid 702 must be set to a such a level as enabling the lid 702 to be melted, but as not melting the cartridge cover 30. As in the case of FIG. 6, induction heating may be used instead of irradiating the laser beam 61.

In the illustrated instance, a space is left above a surface level of the reagent 703 in the reagent-containing closed vessel 700. Stated another way, the surface level of the reagent 703 is away from the lid 702. Accordingly, even when the lid 702 is melted by heating, the reagent is not heated. Hence deterioration of the reagent is avoided. By using a material having a high absorbance for the laser beam 61 to form the lid 702, the lid can be melted by irradiating the laser beam 61 at a minimum energy level. When an ID marker is affixed to the lid 702, the ID marker may be formed by coating a paint having high energy absorbency, e.g., a black paint.

FIG. 20C shows a state where a part of the lid 702 is melted and the hole 708 is formed. Then, as shown in FIG. 20D, the cartridge cover 30 is pierced in the piercing-target portion 23. The reagent in the vessel is thereby communicated with the atmospheric pressure via a hole 31. Then, as shown in FIG. 20E, the holding disk 12 is rotated. The reagent in the vessel is flown out in the direction of an arrow 63 through the hole 708 of the lid 702 under the action of centrifugal force 62 to move toward another vessel in the outer peripheral side via the outlet flow channel 22.

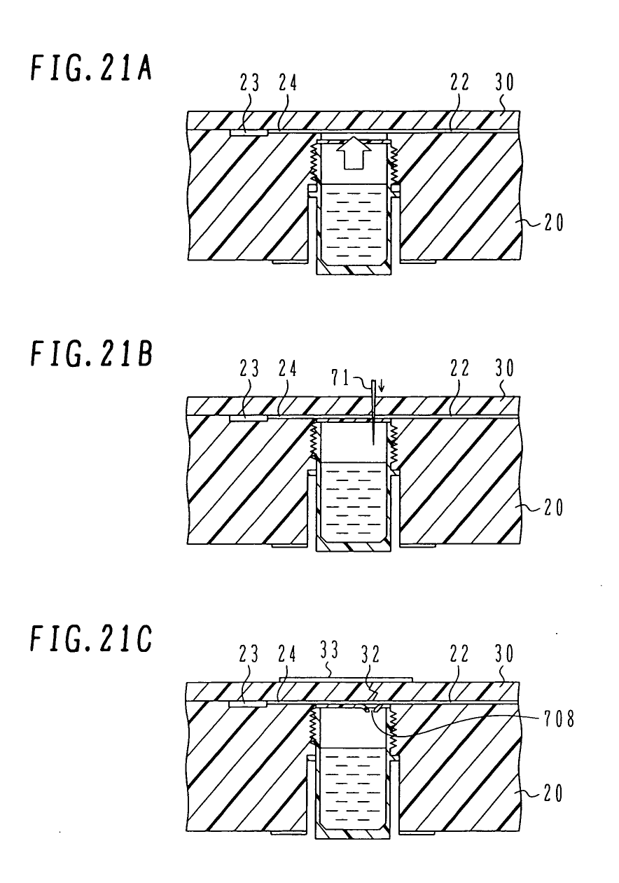

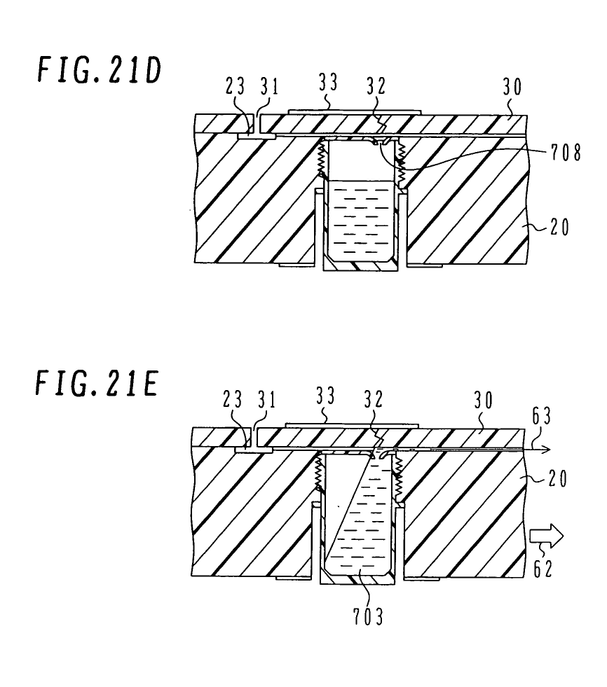

FIGS. 21A-21E show a series of manipulations necessary for the third example of the reagent vessel mounted to the test cartridge 20 similarly to FIGS. 20A-20E. The manipulations shown in FIGS. 21A-21E differ from those shown in FIGS. 20A-20E in a manner of forming the hole in the lid. The manner of forming the hole in the lid in the third example is similar to that in the case of FIG. 15. FIG. 21A is the same as FIG. 20A and shows the state where the reagent-containing closed vessel 700 is mounted to the test cartridge 20.

As shown in FIG. 21B, a needle 71 is pierced through the lid 702. The needle 71 is pushed down from above the cartridge cover 30 to penetrate through the cartridge cover 30 to such an extent that the needle 71 is pierced into the lid 702 of the reagent-containing closed vessel 700 positioned below the cartridge cover 30. As a result, the hole 708 is formed in the lid 702.

As shown in FIG. 21C, a hole 32 formed in the cartridge cover 30 by the needle 71 is sealed off by coating a sealing material 33. Then, as shown in FIG. 21D, the cartridge cover 30 is pierced in the piercing-target portion 23. The reagent 703 in the vessel is thereby communicated with the atmospheric pressure via a hole 31. Then, as shown in FIG. 21E, the holding disk 12 is rotated. The reagent 703 in the reagent-containing closed vessel is flown out in the direction of an arrow 63 through the hole 708 of the lid 702 under the action of centrifugal force 62 to move toward another vessel in the outer peripheral side via the outlet flow channel 22.

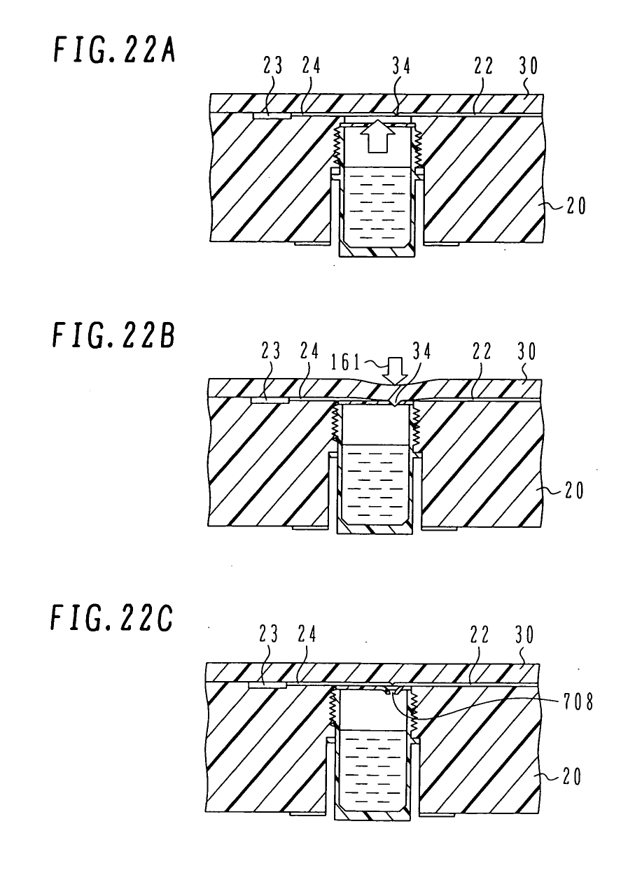

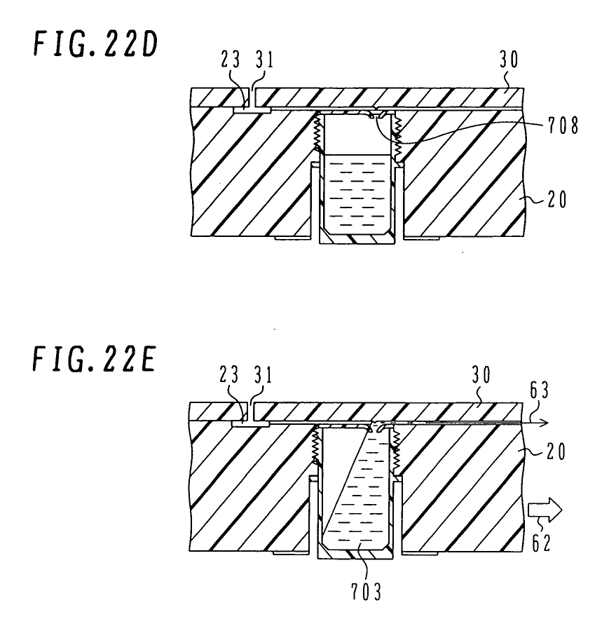

FIGS. 22A-22E show a series of manipulations necessary for the third example of the reagent vessel mounted to the test cartridge 20 similarly to FIGS. 20 and 21. The manipulations shown in FIGS. 22A-22E differ from those shown in FIGS. 20 and 21 in a manner of forming the hole in the lid. The manner of forming the hole in the lid is similar to that in the case of FIG. 16.

FIG. 22A is the same as FIG. 21A and shows the state where the reagent vessel is mounted to the test cartridge 20. In this instance, a projection 34 is formed on a lower surface of the cartridge cover 30. The projection 34 is formed so as to position just above the lid 702 of the reagent-containing closed vessel 700.

As shown in FIG. 22B, the cartridge cover 30 is depressed downward from above, as indicated by 161, at the position where the projection 34 is formed. With the depression of the cartridge cover 30, the projection 34 is pushed against the lid 702 and the hole 708 is formed in the lid 702. FIG. 22C shows the state where the hole 708 is formed in the lid 702 of the reagent-containing closed vessel 700.

As shown in FIG. 22D, the cartridge cover 30 is pierced in the piercing-target portion 23. The reagent 703 in the vessel is thereby communicated with the atmospheric pressure via a hole 31. Then, as shown in FIG. 22E, the holding disk 12 is rotated. The reagent 703 in the reagent-containing closed vessel is flown out in the direction of an arrow 63 through the hole 708 of the lid 702 under the action of centrifugal force 62 to move toward another vessel in the outer peripheral side via the outlet flow channel 22.

In the instances shown in FIGS. 20-22, the hole 708 formed in the lid 702 is preferably positioned nearer to the outlet flow channel 22 than to the center of the lid 702. Stated another way, the hole 708 formed in the lid 702 is preferably formed at a position biased toward the outlet flow channel 22 away from the center of the lid 702.

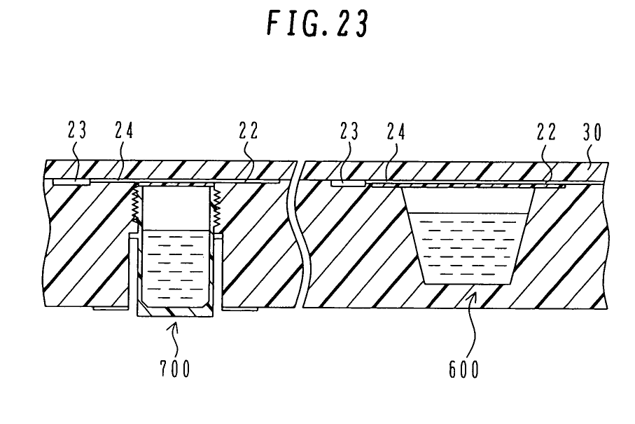

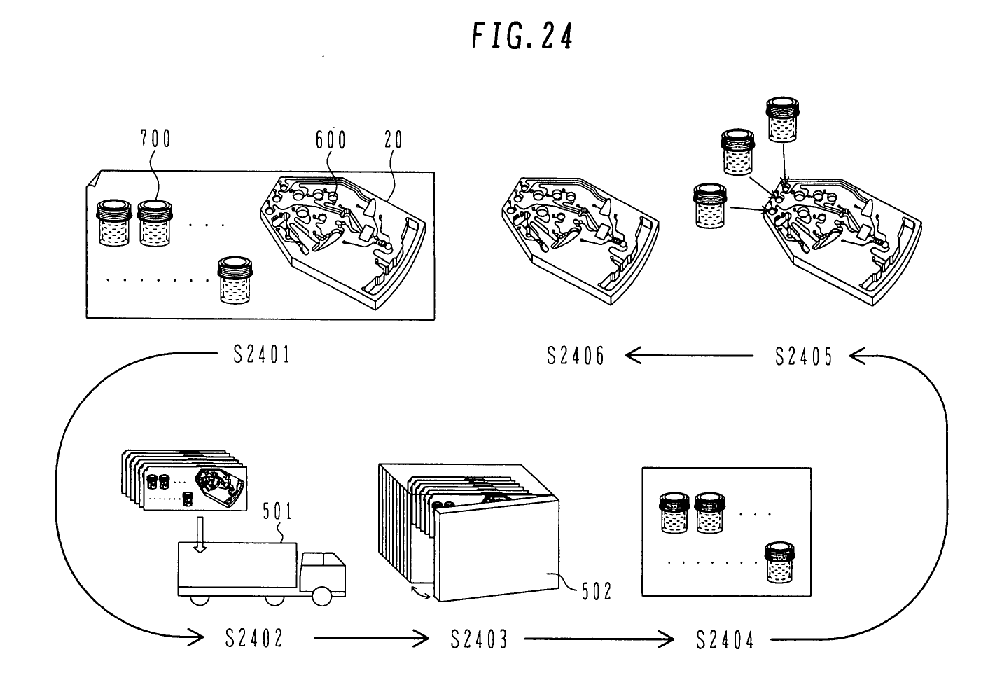

Another example of the test cartridge according to the present invention will be described below with reference to FIGS. 23 and 24. In this example, as shown in FIG. 23, the reagent-containing closed vessel 600 shown in FIGS. 9-16 and the reagent-containing closed vessel 700 of the screw-in type shown in FIGS. 7-22 are both mounted to one test cartridge. In this example, a reagent requiring special pretreatment prior to the start of a test is dispensed into the reagent-containing closed vessel 700 of the screw-in type and is delivered without being mounted to the test cartridge 20. On the other hand, a reagent requiring no pretreatment prior to the start of a test is enclosed in the reagent-containing closed vessel 600 and is packaged after being mounted to the test cartridge 20 in advance.

FIG. 24 illustrates the flow of operations ranging from a packaging step, then a delivery step, to a test step of the test cartridge 20 according to this example. In step S2401, only the closed vessel 600 containing the reagent which requires no pretreatment prior to the start of a test is packaged after being mounted to the test cartridge 20, and the closed vessel 700 containing the reagent which requires pretreatment prior to the start of a test is packaged without being mounted to the test cartridge 20. In step S2402, those products are delivered by using, e.g., a refrigerator truck 501, and in step S2403, the delivered products are preserved in environment controllable equipment, e.g., a cool box 502, on the receiving side. In step S2404, the predetermined pretreatment is performed on the reagent enclosed in the closed vessel 700 in a test facility, etc. In step S2405, the reagent-containing closed vessel 700 is mounted to the test cartridge 20. In step S2406, the test cartridge 20 is mounted to the holding disk 12, and the holding disk 12 is rotated.

In view of that the reagent-containing closed vessel 700 of the screw-in type is mounted to the test cartridge by a test operator, the reagent-containing closed vessel 700 of the screw-in type and the reagent port 21 corresponding to the former are provided with means for preventing them from being falsely mounted. Those means can be constituted, for instance, by affixing the predetermined ID marks to the reagent-containing closed vessel 700 of the screw-in type and the corresponding reagent port 21, or by forming the paired vessels and ports in different shapes or sizes per reagent.

Thus, by dispensing the reagent requiring special pretreatment and the reagent requiring no pretreatment into the different types of vessels, a trouble of taking one of those reagents for the other can be prevented. In addition, for the reason that the reagent-containing closed vessel 700 of the screw-in type is mounted to the test cartridge by the test operator, the reagent-containing closed vessels 700 of the screw-in type and the corresponding reagent port 21 have to be provided with the ID means.

According to the present invention, since the reagent vessel is previously placed on or mounted to the test cartridge and the test cartridge including the reagent vessel is packaged after sealing it by the cartridge cover, those products can be handled as a reagent-cartridge kit adapted for each of test targets.

On the other hand, the test operator is able to perform a test just by dispensing whole blood with no need of the operation for dispensing reagents.

According to the present invention, it is possible to not only provide a cartridge having a simple structure and a chemical analyzer using the cartridge, but also to eliminate instability in fluid mobility attributable to operations performed by the test operator and factors impeding tests.

While several examples of the present invention have been described, it is to be understood by those skilled in the art that the present invention is not limited to the above-described examples and can be modified in various ways without departing the scope of the invention defined in claims.

1. A chemical analyzer comprising a holding disk rotatable about a rotation axis passing the center of said holding disk, and a test cartridge detachably held by said holding disk,
said test cartridge comprising a base plate including vessels and flow channels, and a cover for covering said vessels and flow channels,
said holding disk being rotated to generate centrifugal force, thereby causing a fluid to be moved from one vessel positioned in the inner peripheral side with respect to said rotation axis to another vessel positioned in the outer peripheral side with respect to said rotation axis via the flow channel,
wherein said test cartridge includes at least one reagent port formed in said base plate and at least one closed vessel placed in said reagent port and containing a reagent enclosed therein.

2. The chemical analyzer according to claim 1, wherein said closed vessel is a microcapsule containing a reagent, and said reagent port is a recess formed in said base plate.

3. The chemical analyzer according to claim 1, wherein said closed vessel comprises a plastic-made vessel body containing a reagent and a plastic-made lid, and said reagent port is a recess formed in said base plate.

4. The chemical analyzer according to claim 1, wherein said closed vessel comprises a vessel body containing a reagent, a lid, and a threaded portion formed on an outer periphery of said vessel body, and said reagent port is a through hole formed in said base plate and having a threaded portion, said closed vessel being mounted to said reagent port by engaging the threaded portion of said closed vessel with the threaded portion of said reagent port.

5. The chemical analyzer according to claim 1, wherein identification markers corresponding to each other are affixed to said reagent port and said closed vessel.

6. The chemical analyzer according to claim 5, wherein said identification markers are each given in the form including at least one of a character, a symbol, a color, and a shape.

7. The chemical analyzer according to claim 2, further comprising rupture means for rupturing said microcapsule.

8. The chemical analyzer according to claim 7, wherein said rupture means is laser beam irradiating means for irradiating a laser beam to said microcapsule through said cover.

9. The chemical analyzer according to claim 7, wherein said rupture means includes a needle pierced into said microcapsule.

10. The chemical analyzer according to claim 3, further comprising rupture means for rupturing said lid.

11. The chemical analyzer according to claim 10, wherein said rupture means is one of laser beam irradiating means for irradiating a laser beam to said lid through said cover, a needle pierced into said lid through said cover, and a projection formed on said cover.

12. The chemical analyzer according to claim 1, wherein said closed vessel includes a plastic-made vessel containing a reagent and a screw-in closed vessel containing a reagent and having a threaded portion formed on an outer periphery thereof, said plastic-made reagent-containing closed vessel being placed in a recess formed in said base plate, said screw-in closed vessel being engaged with a threaded portion of a recess formed in said base plate.

13. A cartridge for a chemical analyzer, comprising a base plate including vessels and flow channels, and a cover for covering said vessels and flow channels,
said cartridge being rotated about a rotation axis perpendicular to said base plate to generate centrifugal force, thereby causing a fluid to be moved from one vessel positioned in the inner peripheral side with respect to said rotation axis to another vessel positioned in the outer peripheral side with respect to said rotation axis via the flow channel,
wherein said test cartridge includes at least one reagent port formed in said base plate and at least one closed vessel placed in said reagent port and containing a reagent enclosed therein.

14. The cartridge for the chemical analyzer according to claim 13, wherein said closed vessel is a microcapsule containing a reagent, and said reagent port is a recess formed in said base plate.

15. The cartridge for the chemical analyzer according to claim 13, wherein said closed vessel comprises a plastic-made vessel body containing a reagent and a plastic-made lid, and said reagent port is a recess formed in said base plate.

16. The cartridge for the chemical analyzer according to claim 13, wherein said closed vessel comprises a vessel body containing a reagent, a lid, and a threaded portion formed on an outer periphery of said vessel body, and said reagent port is a through hole formed in said base plate and having a threaded portion, said closed vessel being mounted to said reagent port by engaging the threaded portion of said closed vessel with the threaded portion of said reagent port.

17. The cartridge for the chemical analyzer according to claim 13, wherein identification markers corresponding to each other are affixed to said reagent port and said closed vessel.

18. The cartridge for the chemical analyzer according to claim 17, wherein said identification markers are given in the form including at least one of a character, a symbol, a color, and a shape.

19. The cartridge for the chemical analyzer according to claim 13, wherein said closed vessel includes a plastic-made vessel containing a reagent and a screw-in closed vessel containing a reagent and having a threaded portion formed on an outer periphery thereof, said plastic-made reagent-containing closed vessel being placed in a recess formed in said base plate, said screw-in closed vessel being engaged with a threaded portion of a recess formed in said base plate.

20. A chemical analysis kit comprising a chemical analysis cartridge and at least one closed vessel containing a reagent enclosed therein, said cartridge comprising a base plate including vessels and flow channels, and a cover for covering said vessels and flow channels,
said cartridge being rotated about a rotation axis perpendicular to said base plate to generate centrifugal force, thereby causing a fluid to be moved from one vessel positioned in the inner peripheral side with respect to said rotation axis to another vessel positioned in the outer peripheral side with respect to said rotation axis via the flow channel,
wherein said closed vessel is detachably set in a reagent port formed in said base plate.

21. The chemical analysis kit according to claim 20, wherein said closed vessel includes a closed vessel previously set in said reagent port formed in said base plate, and a closed vessel separated from said chemical analysis cartridge.

22. The chemical analysis kit according to claim 21, wherein identification markers for preventing false setting are affixed to said closed vessel separated from said chemical analysis cartridge and the reagent port in which said closed vessel is to be set.

23. The chemical analysis kit according to claim 21, wherein said closed vessel separated from said chemical analysis cartridge is mounted to the reagent port, in which said closed vessel is to be set, by screwing from one side of said base plate oppose to the other side covered with said cover.
